(19) United States
(12) Patent Application Publication
(10) Pub. No.: US 2023/0216581 A1
(43) Pub. Date: Jul. 6, 2023

(54) SATELLITE HANDOVER MANAGEMENT IN A BROADBAND COMMUNICATION SYSTEM

(71) Applicant: SOLANA TECHNOLOGIES INC., VISTA, CA (US)

(72) Inventors: KENNETH STANWOOD, VISTA, CA (US); DAVID GELL, SAN DIEGO, CA (US)

(73) Assignee: SOLANA TECHNOLOGIES INC., VISTA, CA (US)

(21) Appl. No.: 18/008,466

(22) PCT Filed: Jun. 22, 2021
(86) PCT No.: PCT/US2021/038399

§ 371 Date: Dec. 6, 2022

Related U.S. Application Data
(60) Provisional application No. 63/044,295, filed on Jun. 25, 2020.

(51) Int. Cl. H04B 7/185

(52) U.S. Cl. CPC H04B 7/18541; H04B 7/18578

(57) ABSTRACT

A mobile station provided in a satellite communication network comprised of multiple orbiting satellites, wherein the mobile station includes a transceiver that is capable of communication with each of the multiple orbiting satellites, the communication comprising an uplink communication channel and a downlink communication channel, a memory storing data and executable program instructions, and a processor coupled to the transceiver and to the memory, the processor configured to execute the executable program instructions to manage satellite communication handover by performing the steps of maintaining a current communication link between the mobile station and a first orbiting satellite of the multiple orbiting satellites if a signal quality of the current communication link is greater than a first signal quality threshold, identifying at least a second orbiting satellite and a third orbiting satellite of the multiple orbiting satellites as handover candidates based on a relative position of the mobile station to the multiple orbiting satellites, wherein a relative distance of the mobile station to the second orbiting satellite is less than a relative distance of the mobile station to the third orbiting satellite, handing over communication of the mobile station to the third orbiting satellite if the signal quality of the current communication link is not greater than the first signal quality threshold and if a projected signal quality of a communication link between the mobile station and the third orbiting satellite is greater than a second signal quality threshold, and handing over communication of the mobile station to the second orbiting satellite if the signal quality of the current communication link is not greater than the first signal quality threshold and if the projected signal quality of a communication link between the mobile station and the third orbiting satellite is not greater than a second signal quality threshold and if a projected signal quality of a communication link between the mobile station and the second orbiting satellite is greater than a third signal quality threshold.

### BACKGROUND OF THE INVENTION

### 1. Field of Invention

The inventions herein relate to broadband communications, broadband wireless communications, and broadband communications over satellite. The inventions herein further relate to segmenting data such as streaming video into separate connections, such as TCP or PPP, for transport over these communications systems to provide sufficient video playback at a user device such as a mobile station during unstable communication time periods. The inventions herein further relate to managing communication handover of a mobile station from one satellite to one or more subsequent satellites in a satellite communication system.

### 2. Description of Related Art

Streaming video transported over communications networks from a content delivery network to a user device, such as a mobile station, is often broken up a priori into segments. For instance, Microsoft video streaming services divide video into 2 second segments while Apple video streaming services divide video into 10 second segments. These are typically available at a number of different resolutions. With newer protocols such as HTTP/2.0, it is desirable to send many segments on a persistent TCP connection. However, as was common with HTTP/1.0 one or more segments may be transported as separate TCP connections so that the sets of segments may be relatively independent of each other in terms of data rate, completeness, routing, etc.

In terrestrial wireless communications such as LTE, packet loss, subsequent retransmission, and the resultant delay is more common than in wired networks. This can be more pronounced in airborne wireless communications networks such as might be provided by constellations of satellites (LEO, VLEO), balloons, planes, etc. The user device may be fixed, portable, or mobile. There may be gaps in coverage for the user device in such wireless communications networks.

In a satellite communications network there may be time periods during which a handover occurs, such as a handover of a mobile station (MS) to a new satellite, a handover of a satellite to another satellite, and a handover of a satellite to a new ground station. Coverage gaps of data communication can occur during these unstable time periods and also during time periods when the mobile station is not in communication with any satellite. As a result, packet loss can occur during these unstable time periods resulting in negative consequences at the mobile station, such as stalling of video playback, for example. Additionally, a handover of a mobile station from one satellite to one or more subsequent satellites may often result in a new communication link between the mobile station and the subsequent satellite that is not sufficient for, or that adversely impacts, communication-based services that operate on the mobile station. The handover to the new communication link may result in insufficient throughput (bandwidth), stability, signal quality, delay, and/or other communication parameters. For example, a communication handover of the mobile station to a subsequent satellite can result in a new communication link between the mobile station and the subsequent satellite that impacts the number and duration of stable and unstable communication time periods experienced by the mobile station.

### SUMMARY OF THE INVENTION

In an aspect, a mobile station is provided in a satellite communication network comprised of multiple orbiting satellites, the mobile station including a communication time period estimator that estimates multiple communication time periods when the mobile station will be capable of communication with at least one satellite in the satellite communication network and that identifies one of the multiple communication time periods as a stable communication time period and another of the multiple communication time periods as an unstable communication time period, a video segment requester that determines a number of video segments to receive during the stable communication time period, the determined number of video segments being sufficient for video playback on the mobile station during the stable communication time period and the unstable communication time period, a transceiver that requests the determined number of video segments, and receives the determined number of video segments, during the stable communication time period from a content delivery network over a connection between the mobile station and the content delivery network via communication of the mobile station with a satellite in the satellite communication network, and a video player that plays the received determined number of video segments over the stable communication time period and the unstable communication time period.

In another aspect, a mobile station is provided in a satellite communication network comprised of multiple orbiting satellites, the mobile station including a communication time period manager that receives, over a current communication between the mobile station and a satellite in the satellite communication network, multiple communication time periods when the mobile station will be capable of communication with at least one satellite in the satellite communication network, wherein one of the multiple communication time periods is identified as a stable communication time period and one other of the multiple communication time periods is identified as an unstable communication time period, a video segment requester that determines a number of video segments to receive during the stable communication time period, the determined number of video segments being sufficient for video playback on the mobile station during the stable communication time period and the unstable communication time period, a transceiver that requests the determined number of video segments, and receives the determined number of video segments, during the stable communication time period from a content delivery network over a connection between the mobile station and the content delivery network via communication of the mobile station with a satellite in the satellite communication network, and a video player that plays the received determined number of video segments over the stable communication time period and the unstable communication time period.

In an aspect, a method is provided for video playback on a mobile station provided in a satellite communication network comprised of multiple orbiting satellites, the method including estimating multiple communication time periods when the mobile station will be capable of communication with at least one satellite in the satellite communication network and identifying one of the multiple communication time periods as a stable communication time period and another of the multiple communication time periods as an unstable communication time period, determining a number of video segments to receive during the stable communication time period, the determined number of video segments being sufficient for video playback on the mobile station during the stable communication time period and the unstable communication time period, requesting the determined number of video segments during the stable communication time period from a content delivery network over a connection between the mobile station and the content delivery network via communication of the mobile station with a satellite in the satellite communication network, receiving, via the connection between the mobile station and the content delivery network, the determined number of video segments, and playing, in a video player in the mobile station, the received determined number of video segments over the stable communication time period and the unstable communication time period.

In another aspect, a method is provided for video playback on a mobile station provided in a satellite communication network comprised of multiple orbiting satellites, the method including receiving, over a current communication between the mobile station and a satellite in the satellite communication network, multiple communication time periods when the mobile station will be capable of communication with at least one satellite in the satellite communication network, wherein one of the multiple communication time periods is identified as a stable communication time period and one other of the multiple communication time periods is identified as an unstable communication time period, determining a number of video segments to receive during the stable communication time period, the determined number of video segments being sufficient for video playback on the mobile station over the stable communication time period and the unstable communication time period, requesting the determined number of video segments during the stable communication time period from a content delivery network over a connection between the mobile station and the content delivery network via communication of the mobile station with a satellite in the satellite communication network, receiving the determined number of video segments during the stable communication time period from the content delivery network over the connection between the mobile station and the content delivery network, and playing, on a video player in the mobile station, the received determined number of video segments over the stable communication time period and the unstable communication time period.

In an aspect, a mobile station is provided in a satellite communication network comprised of multiple orbiting satellites, wherein the mobile station includes a transceiver that is capable of communication with each of the multiple orbiting satellites, the communication comprising an uplink communication channel and a downlink communication channel, a memory storing data and executable program instructions, and a processor coupled to the transceiver and to the memory, the processor configured to execute the executable program instructions to manage satellite communication handover by performing the steps of maintaining a current communication link between the mobile station and a first orbiting satellite of the multiple orbiting satellites if a signal quality of the current communication link is greater than a first signal quality threshold, identifying at least a second orbiting satellite and a third orbiting satellite of the multiple orbiting satellites as handover candidates based on a relative position of the mobile station to the multiple orbiting satellites, wherein a relative distance of the mobile station to the second orbiting satellite is less than a relative distance of the mobile station to the third orbiting satellite, handing over communication of the mobile station to the third orbiting satellite if the signal quality of the current communication link is not greater than the first signal quality threshold and if a projected signal quality of a communication link between the mobile station and the third orbiting satellite is greater than a second signal quality threshold, and handing over communication of the mobile station to the second orbiting satellite if the signal quality of the current communication link is not greater than the first signal quality threshold and if the projected signal quality of a communication link between the mobile station and the third orbiting satellite is not greater than a second signal quality threshold and if a projected signal quality of a communication link between the mobile station and the second orbiting satellite is greater than a third signal quality threshold.

In another aspect, a mobile station is provided in a satellite communication network comprised of multiple orbiting satellites, the mobile station including a transceiver that is capable of communication with each of the multiple orbiting satellites, said communication comprising an uplink communication channel and a downlink communication channel, a memory storing data and executable program instructions, and a processor coupled to the transceiver and to the memory, the processor configured to execute the executable program instructions to manage satellite communication handover by performing the steps of determining a first available communication bandwidth and a first communication delay for a first potential communication link between the mobile station and a first orbiting satellite, and determining a second available communication bandwidth and a second communication delay for a second potential communication link between the mobile station and a second orbiting satellite, selecting for communication handover of the mobile station, if the first available communication bandwidth and the second available communication bandwidth are not both above a first bandwidth threshold, one of the first orbiting satellite and the second orbiting satellite based on which one of the first available communication bandwidth and the second available communication bandwidth is highest, and selecting for communication handover of the mobile station, if the first available communication bandwidth and the second available communication bandwidth are both above a first bandwidth threshold and if the first communication delay and the second communication delay are not both below a first delay threshold, one of the first orbiting satellite and the second orbiting satellite based on which one of the first communication delay and the second communication delay is lowest.

In an aspect, a mobile station is provided in a satellite communication network comprised of multiple orbiting satellites, the mobile station including a transceiver that is capable of a communication link with each of the multiple orbiting satellites, said communication link comprising an uplink communication channel and a downlink communication channel, a memory storing data and executable program instructions, and a processor coupled to the transceiver and to the memory, the processor configured to execute the executable program instructions to generate a satellite communication handover plan instruction by determining a handover plan time duration, determining a set of at least two handover paths, each handover path including a sequence of at least one communication handover of the mobile station from one orbiting satellite to a subsequent orbiting satellite based on a predicted relative position of the mobile station to the multiple orbiting satellites during the handover plan time duration, determining a total handover cost estimate for each handover path based on a handover cost estimate for each communication handover in the handover path, each handover cost estimate being determined by utilizing a cost function based on a set of predicted communication parameters associated with a communication link between the mobile station and the orbiting satellite to which the mobile station will be handed over in that communication handover, and generating a satellite communication handover plan by selecting the handover path that has the lowest total handover cost estimate.

In a further aspect, a mobile station provided in a satellite communication network comprised of multiple orbiting satellites, the mobile station including a transceiver that is capable of communication with each of the multiple orbiting satellites, said communication comprising an uplink communication channel and a downlink communication channel, a memory storing data and executable program instructions, and a processor coupled to the transceiver and to the memory, the processor configured to execute the executable program instructions to select one of a first orbiting satellite and a second orbiting satellite for communication with the mobile station by determining a first available communication bandwidth and a first communication delay for a first communication link between the mobile station and the first orbiting satellite, and determining a second available communication bandwidth and a second communication delay for a second communication link between the mobile station and the second orbiting satellite, selecting the first orbiting satellite for communication with the mobile station if the first available communication bandwidth is greater than the second available communication bandwidth and the first communication delay is less than the second communication delay, or if the first available communication bandwidth is greater than the second available communication bandwidth and the first communication delay is greater than the second communication delay and the second available communication bandwidth is not above a second bandwidth threshold, or if the first available communication bandwidth is less than the second available communication bandwidth and the first communication delay is less than the second communication delay and the first available communication bandwidth is above a first bandwidth threshold, and selecting the second orbiting satellite for communication with the mobile station if the first available communication bandwidth is less than the second available communication bandwidth and the first communication delay is greater than the second communication delay, or if the first available communication bandwidth is less than the second available communication bandwidth and the first communication delay is less than the second communication delay and the first available communication bandwidth is not above the first bandwidth threshold, or if the first available communication bandwidth is greater than the second available communication bandwidth and the first communication delay is greater than the second communication delay and the second available communication bandwidth is above the second bandwidth threshold.

The foregoing aspects, and other features and advantages of the invention, will be apparent from the following, more particular description of exemplary aspects of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a top-level system diagram of a mobile station in a satellite communication network according to aspects of the invention;

FIG. 2 is a system diagram depicting various communications of satellites, ground stations and a mobile station in a satellite communication network according to aspects of the invention;

FIG. 3 is a system diagram showing coverage areas of satellites and ground stations in a satellite communication network according to aspects of the invention;

FIG. 4 is a diagram depicting a constellation of low earth orbit (LEO) satellites in a satellite communication network according to aspects of the invention;

FIG. 5 is a timing diagram illustrating various upcoming communication time periods for a mobile station in a satellite communication network according to aspects of the invention;

FIG. 6 is a functional block diagram depicting various functional blocks of a mobile station in a satellite communication network according to aspects of the invention;

FIG. 7 is a flowchart that illustrates a process performed by a mobile station for controlling delivery of video streaming to the mobile station in a satellite communication network according to aspects of the invention;

FIG. 8A is a flowchart that illustrates the estimation of satellite orbit positions and paths at a mobile station according to aspects of the invention;

FIG. 8B is a flowchart that illustrates the obtainment of satellite orbit positions and paths at a mobile station according to aspects of the invention;

FIG. 9 is a flowchart that illustrates the estimation of signal quality values at a mobile station according to aspects of the invention;

FIG. 10 is a flowchart that illustrates the estimation of stable and unstable communication time periods at a mobile station according to aspects of the invention;

FIG. 11 is a flowchart that illustrates the determination of at least one video segment request at a mobile station according to aspects of the invention;

FIG. 12 is a flowchart that illustrates an alternative process performed by a mobile station for controlling delivery of video streaming to the mobile station in a satellite communication network according to aspects of the invention;

FIG. 13A is a block diagram that depicts functional components of a base station of a broadband communication network according to aspects of the invention;

FIG. 13B is a block diagram that depicts functional components of a mobile station of a broadband communication network according to aspects of the invention;

FIG. 14 is a top-level system diagram of a mobile station with handover options in a satellite communication network according to aspects of the invention;

FIG. 15A is a flowchart that illustrates a communication handover management process for handover of a mobile station to one of multiple subsequent satellites based on bandwidth or stability optimization according to aspects of the invention;

FIG. 15B is a flowchart that illustrates another communication handover management process for handover of a mobile station to one of multiple subsequent satellites based on stability optimization according to aspects of the invention;

FIG. 16 is a top-level system diagram of a mobile station with handover options illustrating communication delay in a satellite communication network according to aspects of the invention;

FIG. 17 is another top-level system diagram of a mobile station with handover options illustrating communication delay in a satellite communication network according to aspects of the invention;

FIG. 18A is a flowchart that illustrates a communication handover management process for handover of a mobile station to one of multiple subsequent satellites based on bandwidth and delay parameters according to aspects of the invention;

FIG. 18B is a flowchart that illustrates another communication handover management process for handover of a mobile station to one of multiple subsequent satellites based on bandwidth and delay parameters according to aspects of the invention;

FIG. 19 is a top-level system diagram of a satellite communication network illustrating communication blackout areas of one or more satellites according to aspects of the invention;

FIG. 20A is graph illustrating signal quality metrics related to multiple satellite communication links of a satellite handover path for a mobile station according to aspects of the invention;

FIG. 20B is graph illustrating signal quality metrics related to multiple satellite communication links of another satellite handover path for a mobile station according to aspects of the invention;

FIG. 21 is a flowchart that illustrates a communication handover management process for handover of a mobile station to one of multiple subsequent satellites based on cost estimates for potential handover paths according to aspects of the invention;

FIG. 22A is graph illustrating signal quality metrics related to multiple satellite communication links over incremental time slices of a satellite handover path for a mobile station according to aspects of the invention; and

FIG. 22B is graph illustrating signal quality metrics related to multiple satellite communication links over incremental time slices of another satellite handover path for a mobile station according to aspects of the invention.

### DETAILED DESCRIPTION

Aspects of the present invention and their advantages may be understood by referring to the figures, wherein like reference numerals refer to like elements. The descriptions and features disclosed herein can be applied to various devices, systems, software, and methods in broadband communication systems.

Aspects of the present invention provide a mobile station that receives video segments in a controlled manner within a satellite communication network by determining upcoming stable and unstable time communication periods based on estimated satellite paths and a predicted mobile station path, determining at least one video segment request for an upcoming stable communication time period that includes a determined number of video segments sufficient for video playback on the mobile station during the stable communication time period and at least one subsequent unstable communication time period, receiving the determined number of video segments during the stable communication time period and playing back the determined number of video segments at the mobile station during the stable communication time period and the at least one subsequent unstable communication time period.

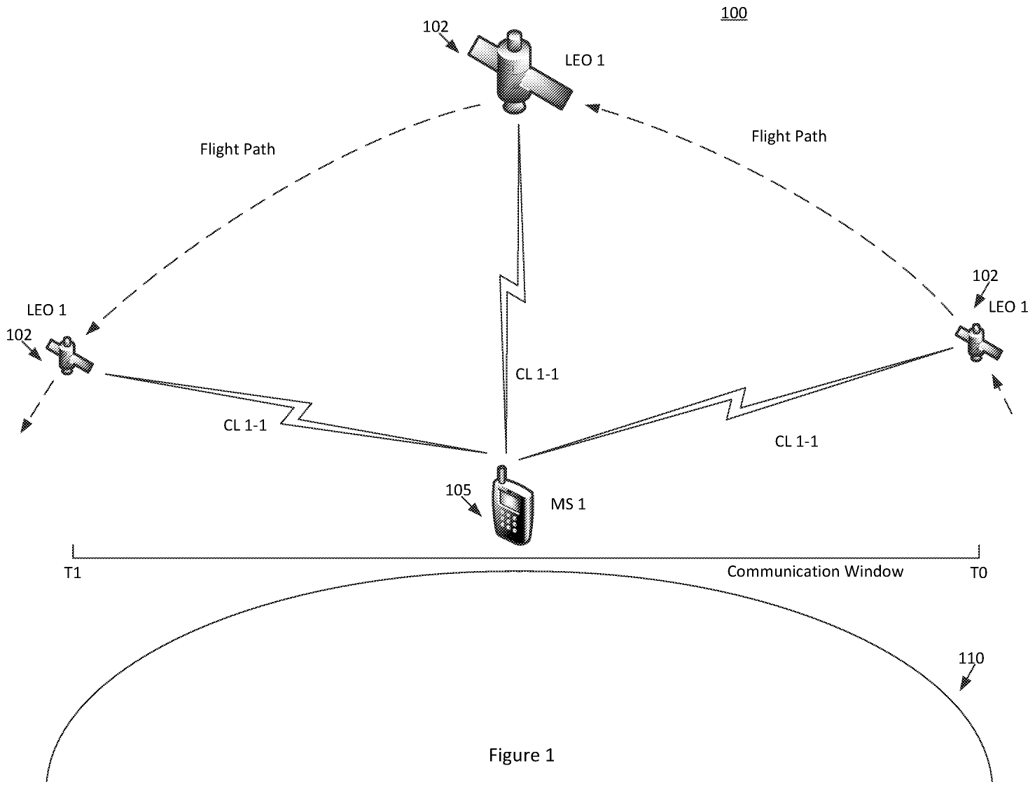

FIG. 1 shows a simplified view of a mobile station MS1 105 communicating with a low earth orbit satellite LEO1 102 via communications link CL1-1.

When the satellite LEO1 102 comes within communication range, from mobile station MS1 105's point of view, at time T0, the two may communicate via communications link CL1-1. This communication may continue until the satellite leaves communication range, from mobile station MS1 105's point of view, at time T1. At or after time T1, mobile station MS1 105 will no longer be able to communicate with satellite LEO1 102. The duration of time that the two may be able to communicate (i.e. T1-T0) is a function of the orbit of satellite LEO1 102 and the time it is in view for MS1 105. For instance, T1-T0 may be somewhere between 1 and 5 minutes for low earth orbit satellites.

The duration of time the two may be able to communicate (i.e. T1-TO) is also a function of their transmit power, receive sensitivity, phase error, modulation choice, frequency channel, design quality, antenna structure, the weather, interference present, and a myriad of other factors known to one skilled in the art. The duration of time that the two may be able to communicate may, for instance, be prolonged by using beamforming and beam tracking/steering at either or both of mobile station MS1 105 and satellite LEO1 102 instead of omnidirectional or wide-beam antennas. As is known to one skilled in the art, satellite LEO1 102 may utilize one or more transmitted spot beams, each of which provide a fraction of LEO1 102's total coverage area.

In a broadband communication system providing continuous communication capability for real-time services such as voice, it may be preferable that mobile station MS1 105 would handoff (or synonymously handover) to another satellite before losing communications with satellite LEO1 102. For other services, where data may be buffered, such as streaming video, controlled gaps in coverage and gaps in service during handover events may be tolerated, and may even be preferred, for power savings purposes.

Therefore, the time that mobile station MS1 105 and satellite LEO1 102 are capable of communicating with each other may be longer than the time that they actually do communicate with each other. The time that they actually do communicate may be a shorter duration and may be affected by, for instance, MS1 105 handing over to another satellite before time T1 or from another satellite after time TO.

While a low earth orbit (LEO) satellite is used as an example, one skilled in the art would understand that the inventions described herein may be applied to a broadband communication system utilizing very low earth orbit satellites (VLEO), balloons, airplanes or any other broadband communication system where such a vehicle with the equivalent of a GSM base transceiver station BTS function, WiMAX base station, UMTS NodeB, LTE evolved NodeB (eNodeB or eNB) or similar base station function is utilized. In such communication systems, the vehicle acting as the base station and the mobile station may move relatively fast and predictably with respect to each other geographically.

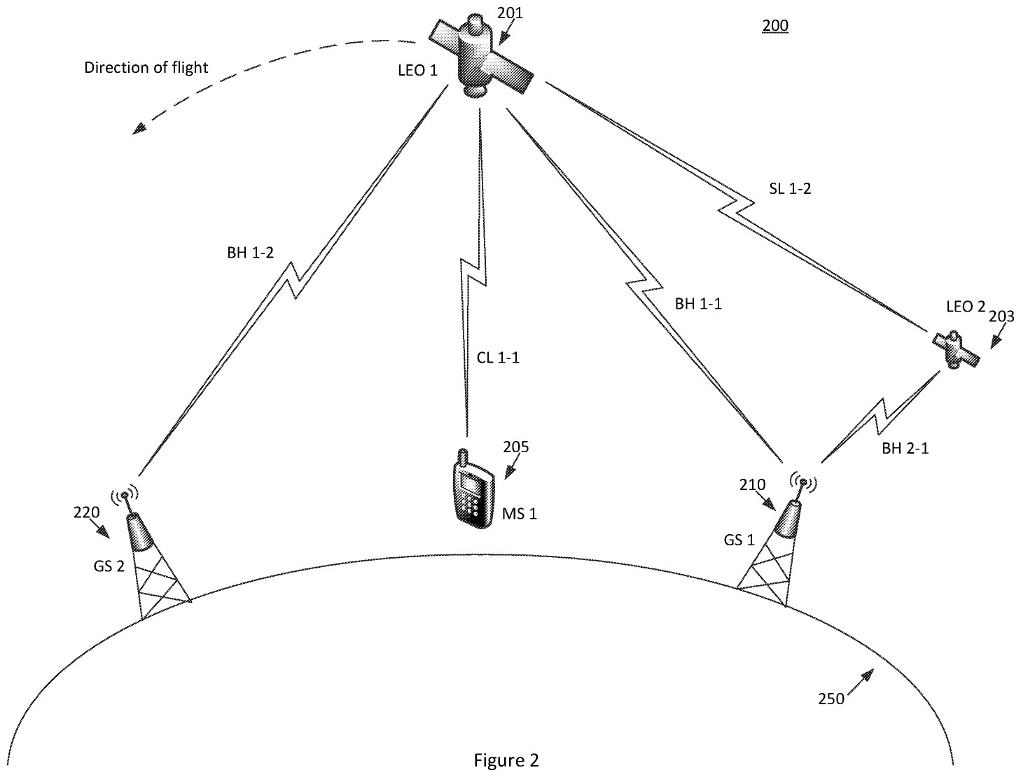

FIG. 2 shows a more detailed system view of a mobile station MS1 205 communicating with a satellite LEO1 201 via communications link CL1-1.

As seen in FIG. 2, satellite LEO1 201 communicates with mobile station MS1 205 via communication link CL1-1. In an aspect, communication link CL1-1 comprises an uplink portion for transmitting data from mobile station MS1 205 to satellite LEO1 201 and a downlink portion for transmitting data from satellite LEO1 201 to mobile station MS1 205.

In an aspect, LEO1 201 provides the equivalent of a base transceiver station function, base station, eNodeB access point, or similar function as would be known to one skilled the art of broadband communication systems such as UMTS, LTE, WiMAX, WiFi, etc. Satellite LEO1 201 communicates with one or more ground stations GS1 210 and GS2 220 over backhauls BH1-1 and BH1-2, respectively. Backhauls, such as BH1-1 and BH1-2, preferable have an uplink portion for transmitting to a satellite and a downlink portion for receiving from a satellite. Satellite LEO1 201 may handover, or synonymously handoff, from one ground station to another, e.g. from ground station GS1 210 to ground station GS2 220, as needed based on the geographic placement of the ground stations relative to the path of flight of satellite LEO1 201.

In a constellation of satellites, as satellite LEO1 201 leaves the view of mobile station MS1 205, one or more other satellites, such as a satellite LEO2, preferably come into view of mobile station MS1 205. A satellite LEO2 will preferably have established communications with one or more ground stations such as ground station GS1 210 over backhaul BH2-1. In an aspect, satellites LEO1 201 and a LEO2 communicate over a two-way communication sidelink SL1-2 which may be a point-to-point link operated as part of a mesh network between the constellation of satellites or other type of satellite-to-satellite (inter-satellite) communication network as would be known to one skilled the art. In an aspect, sidelink SL1-2 may provide communications protocols including the equivalent of the LTE X2 interface or the WiMAX R8 interface. Due to relative motion of the satellites, satellite LEO1 201 may handover to a different sidelink for communication with a different satellite than a LEO2.

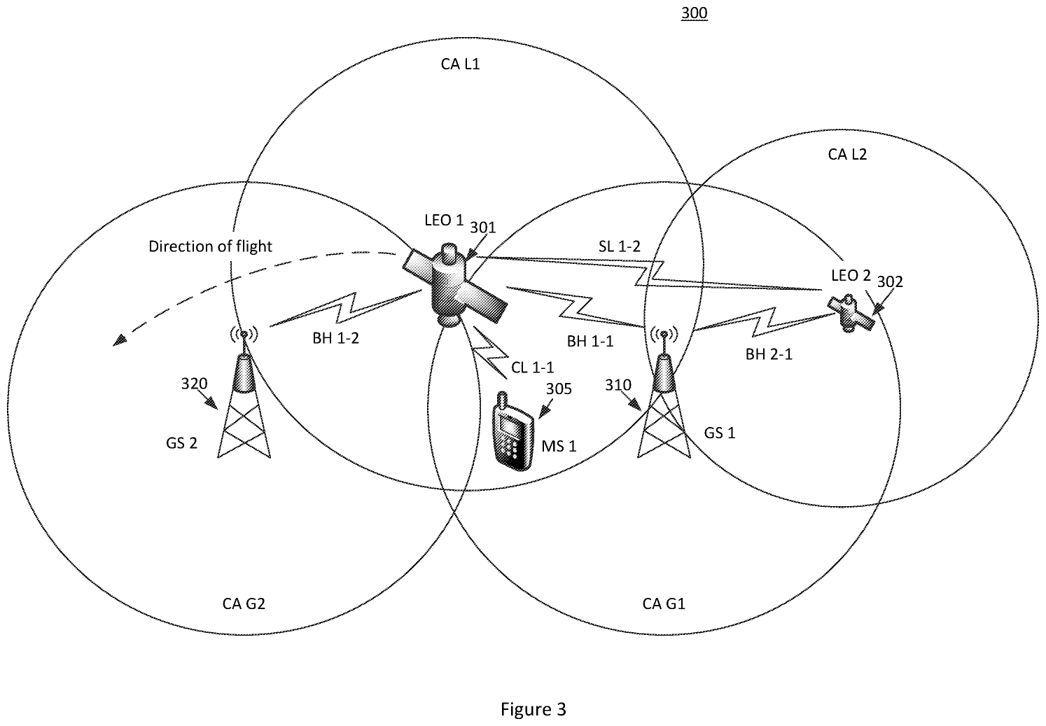

FIG. 3 shows an example of the communication system of FIG. 2 when viewed from above.

As seen in FIG. 3, ground stations GS1 310 and GS2 320 have coverage areas CAG1 and CAG2, respectively. In an aspect, these coverage areas overlap so satellites passing from one coverage area to the next may hand over from one ground station to the next.

Similarly, satellites LEO1 301 and LEO2 302 have coverage areas CAL1 and CAL2, respectively. In an aspect, these coverage areas overlap so mobile stations, such as mobile station MS1 305, may hand over from one satellite to the next as the satellite passes overhead. Note that the above examples are described using only a single mobile station. However, one skilled the art would understand that a satellite may be in communication with one or more mobile stations at any given point in time.

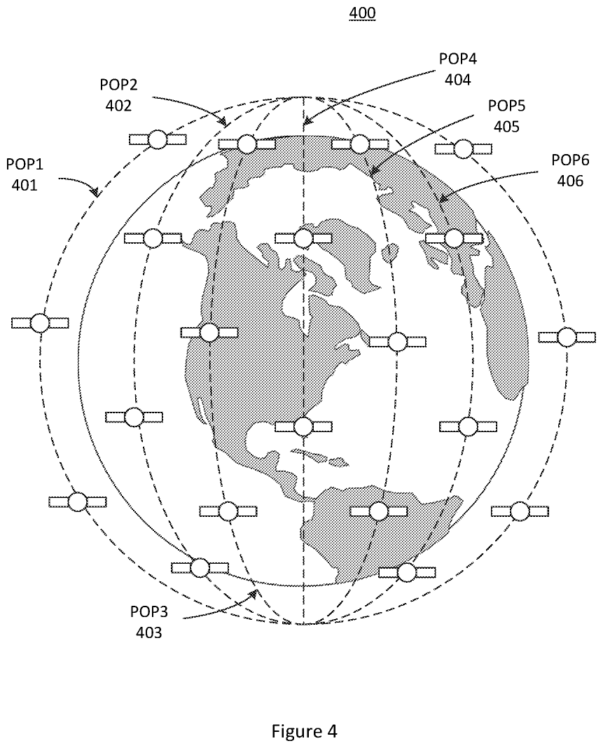

FIG. 4 below shows a picture of the earth with an example of a satellite constellation comprising 6 polar orbits, according to an aspect of the invention. As seen in FIG. 4, a number of satellites each follow the same polar orbit path, labeled POP1 401 through POP6 406. Polar orbits are shown for example only. Other orbital inclinations are well known in the art. Six orbits are shown for example only. Other numbers of orbits are well known in existing and planned satellite constellations. This depicted constellation is useful for describing scenarios that may arise in satellite communications.

Note that some satellites may spend significant time above very large bodies of water, such as the Pacific Ocean. Other satellites may spend significant time over large countries with whom the satellite system operator does not have an agreement to place ground stations. In either case, there may be no suitable place for a ground station to communicate with the satellite in such a situation. With reference to FIG. 3 above, as satellite LEO1 301 leaves the coverage area of ground station GS1 310, there may be no ground station GS2 320 to which it may handover. In this case, satellite LEO2 302 may act as a relay. In this situation, satellite LEO1 301 transmits data received from mobile station MS1 305 on sidelink SL1-2 to satellite LEO2 302. Satellite LEO2 302 forwards that data to ground station GS2 320 on behalf of satellite LEO1 301. Similarly, data bound for mobile station MS1 305 may be transmitted by ground station GS1 310 to satellite LEO2 302 which forwards the data to satellite LEO1 301 on sidelink SL1-2 for transmission to mobile station MS1 305 on communication link CL1-1. Satellites LEO1 301 and LEO2 302 may be on the same orbital path or adjacent orbital paths. In other embodiments, they may be on overlapping orbital paths.

As seen in FIG. 4 there may be substantial overlap of the polar orbit paths POP1 401 through POP6 406 at the poles. This may cause the coverage areas on two or more satellites to substantially overlap simultaneously. Too many satellites operating in the same space at the same time can cause interference. This is aggravated by constellations with more satellites and more polar orbits. It can be alleviated by having some satellites temporarily turn off some or all channels on some or all of their spot beams or other transmission modules. Additionally, some countries disallow certain satellite transmissions while the satellites are passing over their territory. This can be addressed by having the satellite not transmit while transiting over these countries. Both cases cause coverage gaps in the timeline of visibility of that particular satellite. That is to say, there may be times when it is technically possible for the satellite to communicate with a mobile station or ground station, but it does not due to an intentional outage of coverage.

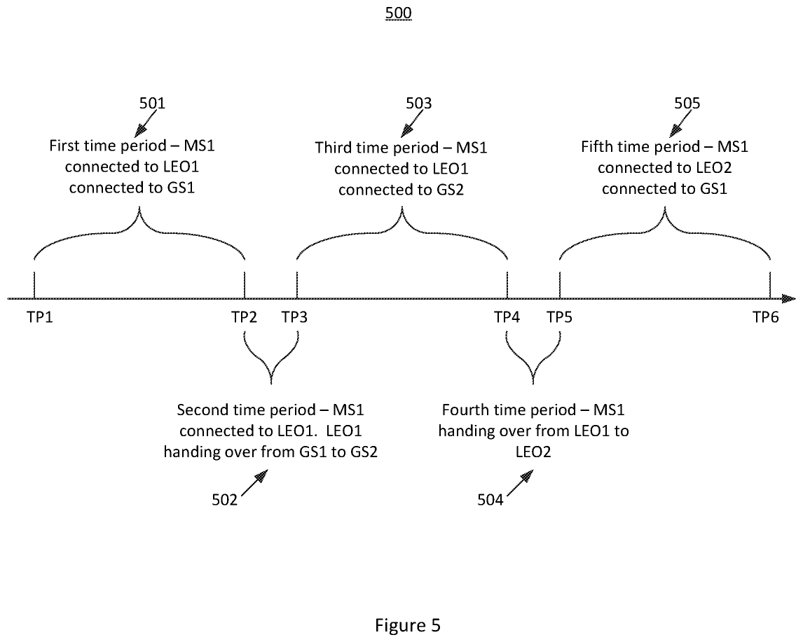

FIG. 5 depicts time periods associated with a handover scenario for a mobile station. Specifically, with reference to FIG. 5, due to satellite a LEO1 handing over from a ground station GS1 to a ground station GS2, there may be a first communication time period 501 during which a mobile station MS1 is connected to satellite LEO1 and the satellite LEO1 is connected with the ground station GS1, a second communication time period 502 during which mobile station MS1 is connected to satellite LEO1 and satellite LEO1 is connected with both ground stations GS1 and GS2 for the purposes of LEO 1 handing over from one ground station to the other. There may be a third communication time period 503 during which mobile station MS1 is connected to satellite LEO1 and satellite LEO1 is connected with ground station GS2. There may be a fourth communication time period 504 during which mobile station MS1 is connected to both satellite LEO1 and satellite LEO2 for the purposes of mobile station MS1 handing over between satellites, satellite LEO1 is connected with ground station GS2 and satellite LEO2 is connected with ground station GS1. There may be a fifth communication time period 505 during which mobile station MS1 is connected to satellite LEO2 and satellite LEO2 is connected with ground station GS1.

As seen in FIG. 5, the first communication time period 501 starts at time TP1 and ends at time TP2. The second communication time period 502 starts at time TP2 and ends at time TP3. The third communication time period 503 starts at time TP3 and ends at time TP4. The fourth communication time period 504 starts at time TP4 and ends at time TP5. The fifth communication time period 505 starts at time TP5 and ends at time TP6. These and similar communication time periods recur, from the point of view of a mobile station MS1 as satellites transition out of view and different satellites transition into view. Communication time periods such as the first communication time period 501, the third communication time period 503, and the fifth communication time period 505 when neither the satellite is handing over to a new ground station nor the mobile station is handing over to a new satellite represent communication time periods which are, from the point of view of the mobile station and its connections, stable communication time periods. Communication time periods such as the second communication time period 502 and the fourth communication time period 504, where one or the other of the satellite or the mobile station is involved in a handover, may be, from the point of view of the mobile station and its TCP connections, unstable communication time periods. For instance, the instability of these communication time periods may cause a TCP connection to break due to needed changes in routing parameters such as IP address, gaps in coverage or excessive lost packets.

Note that, while in FIG. 5 some communication time periods, such as the first communication time period 501 and the third communication time period 503, are shown as the same length visually, this is only for convenience. For instance, if mobile station MS1 were a shorter distance to ground station GS1 than to ground station GS2, the first communication time period 501 would be longer in duration that the third communication time period 503. In fact, the second communication time period 502 and the third communication time period 503 may not exist, depending upon the topology.

With respect to the duration of time that mobile station MS1 and satellite LEO1 may be able to communicate as was shown in FIG. 1, time TO would occur sometime prior to time TP1 and time T1 would occur after time TP4.

To better ensure lossless delivery of streaming video segments to a mobile client MS1, a satellite orbit estimator in mobile station MS1 predicts how long each of the communication time periods will be based on knowledge of the orbits of satellites LEO1, LEO2, and other satellites in the constellation, the position of ground stations, GS1, GS2, and other ground stations in the satellite system, and the current position and velocity of mobile station MS1. This information may be downloaded to the mobile station MS1, accessed over the satellite communication system via a communication link CL1-1, or determined observationally. Known methods and techniques for predicting satellite orbit paths and mobile station paths can be utilized herein in the determination of communication time periods related to mobile station MS1.

To facilitate video delivery to mobile station MS1, based on the predicted communication time periods, a video segment selector in mobile station MS1 determines the attributes of the video segments to request from the video server. The number and representation quality of video segments, and therefore the duration of the TCP connection(s), is determined to best avoid breaking the connection(s) (such as a TCP or PPP connection, for example) due to handover of mobile station MS1 between satellites or due to handover of a satellite, for instance satellite LEO1, between two ground stations. For instance, the set of video segments requested for delivery during the first communication time period 501 may have a duration approximately equal to the sum of the duration the first communication time period 501 and the second communication time period 502 to avoid duplicate segment requests and possible video playback disruption due to the potential for breaking the connection(s) during handover of satellite LEO1 from ground station GS1 to ground station GS2. Similarly, the set of video segments requested for delivery during the third communication time period 503 may have a duration approximately equal to the sum of the duration the third communication time period 503 and the fourth communication time period 504 to avoid duplicate segment requests and possible video playback disruption due to the potential for breaking the connection(s) during handover of mobile station MS1 from satellite LEO1 to satellite LEO2.

However, if the third communication time period 503 is predicted to have a short duration relative to the first communication time period 501, for instance if mobile station MS1 is much closer to ground station GS1, the set of video segments requested for delivery during the first communication time period 501 may have a duration approximately equal to the sum of the duration of the first communication time period 501, the second communication time period 502, the third communication time period 503, and the fourth communication time period 504.

There may be gaps in coverage for a mobile station MS1. For instance, a satellite LEO1 may pass out of view of the mobile station MS1 prior to a satellite LEO2 coming into view. In this case, the fourth communication time period 504 represents a coverage gap. The set of video segments requested for delivery prior to the fourth communication time period 504 may include a sufficient number of segments to keep the video from stalling during the coverage gap.

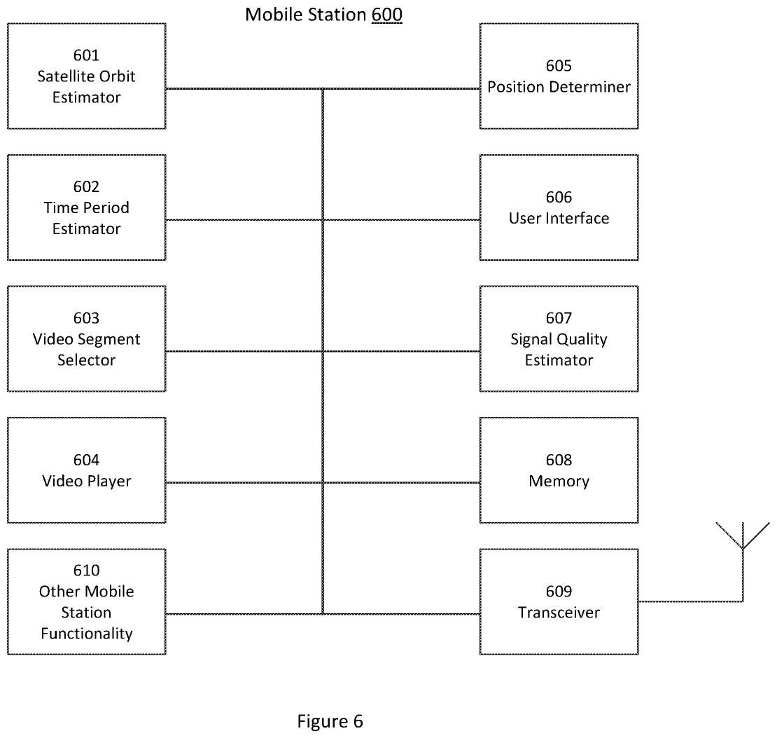

FIG. 6 is a functional block diagram that shows the functionality of mobile station 600 according to aspects of the invention. Mobile station 600 may represent, for example, mobile station MS1 shown in previous figures. The functional blocks of mobile station 600 depicted in FIG. 6 may all communicate and interact with each other by sharing data and/or by sending commands or control signals to each other.

Referring to FIG. 6, Position Determiner 605 determines the position of the mobile station 600. In an embodiment, Position Determiner 605 may be via a satellite positioning system such as, for example, the global positioning system (GPS). It may utilize inertial navigation. Mobile station 600 may accept location coordinates from ground navigation systems or may accept location coordinates from a vehicle in which it resides or of which it is a part, such an airplane, train, or automobile. Other known methods and techniques for determining a position of a mobile station may be utilized for Position Determiner 605.

Position determiner 605, may also calculate an expected path of mobile station 600. The expected path could be based upon a preselected destination and path such as from a flight plan or choosing a destination in a map program such as Google Maps. The expected path could be learned such as learning that the owner of the mobile station typically goes to a work location or a home location at approximately the time of day of the calculation.

Position Determiner 605 may also determine an expected possible area for mobile station 600 over some period of time, for instance 30 minutes. This expected possible area could be based on possible speeds, whether the mobile station is terrestrial and restricted to roads or airborne and not restricted to roads. The expected area may be further overlaid with a probability based on historical data, terrain, etc.

If mobile station 600 is not mobile, but fixed, Position Determiner 605 may determine position, expected path, and expected possible area from the address or input coordinates.

Satellite Orbit Estimator 601 determines the paths of satellites relative to mobile station 600. It may do so for all satellites in a constellation or for only a subset. The subset may be only for those satellites with a high likelihood of being visible to mobile station 600 within a certain time period, for instance 30 minutes. For example, paths may be calculated for satellites on orbital paths, determined or expected to be within a certain distance of the position, expected path, or expected possible area of mobile station 600, within a certain time period, as determined by Position Determiner 605.

Signal Quality Estimator 607 estimates the signal quality with which the mobile station 600 may be able to communicate with one or more satellites during the course of their paths estimated by the Satellite Orbit Estimator 601 and passed upon the position, expected path, or expected possible area of mobile station 600.

Time Period Estimator 602 calculates the time periods of expected stability and possible instability of communication between mobile station 600 and the satellites, including communication gaps, and communication time periods of expected stability and possible instability of communication between satellites and ground stations as described above with reference to FIG. 5.

Video Segment Selector 603 selects groups of video segments to be received during stable communication time periods determined by Time Period Estimator 602. In an embodiment, a group of video segments is comprised of few enough video segments to be received during a stable communication time period while representing enough viewing time duration so as not to have the video playback stall during subsequent unstable communication time periods. In an aspect, each group of selected video segments is transmitted as an independent connection, such as a TCP connection. The video quality and the chosen video representation may be affected by the estimated signal quality and available or assigned communication bandwidth during the stable communication time period.

Video Player 604 buffers video segments for playback to the user. It calculates a video buffer occupancy which is the number of seconds of video that is currently buffered. If no more video segments are received before this number of seconds elapses, all previously received video segments will have been played and the video will stall. It is preferable that the Video Segment Selector 603 requests groups of video segments at a rate sufficient to avoid video playback stalls, in particular by watching for unstable communication time periods.

User Interface 606 provides the typical user interface of a user device, including the display of video, user input, audio output, other known user interface devices, etc.

Memory 608 provides memory for mobile station 600 to buffer video, store data and parameters, and store executable software and/or firmware code such as programs, applications, and operating systems.

Transceiver 609 provides communication functionality between the mobile station 600 and the satellites in the satellite communication network. Known hardware, software, algorithms, techniques, and methods may be utilized to implement the functionality of Transceiver 609. Transceiver 609 measures attributes of signals such as receive signal strength, phase error, SNR, CINR, SINR, and other attributes that may impact the quality and bandwidth of communications between mobile station 600 and the satellites.

Other Mobile Station Functionality 610 contains other known types of functionality that may be necessary or optional for use in mobile station 600.

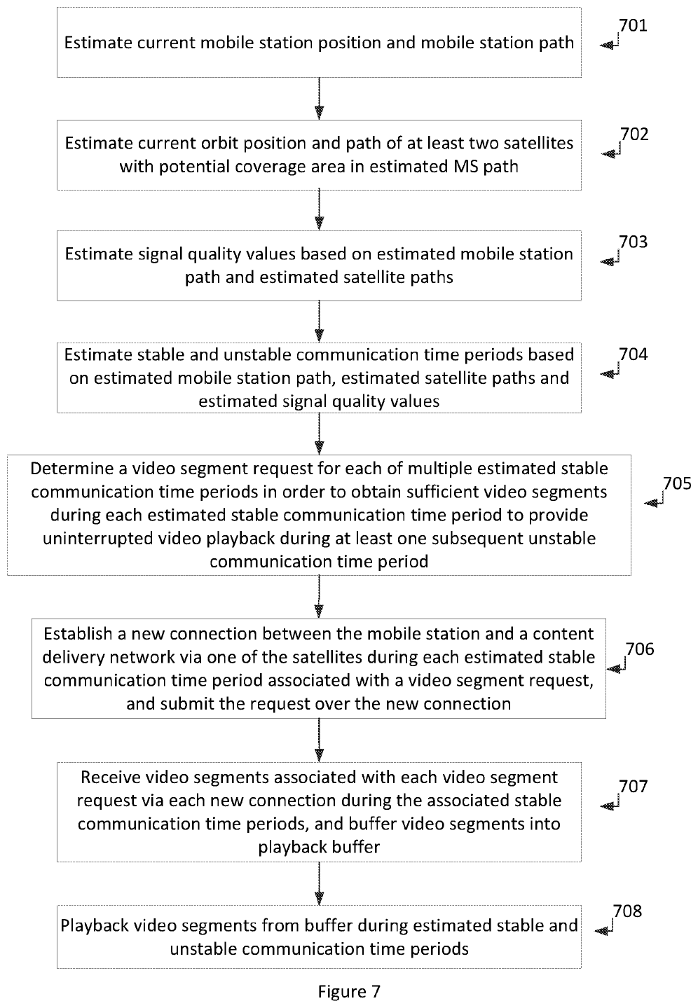

FIG. 7 is a flowchart that illustrates a process performed by a mobile station for controlling delivery of video streaming to the mobile station in a satellite communication network according to aspects of the invention. In step 701, the mobile station (such as mobile station MS1 in previous figures) estimates its own position and an expected mobile station path and may also estimate an expected location area. The mobile station estimates its position, expected mobile station path, and expected location area according to the description provided above for Position Determiner 605 of FIG. 6.

In step 702, the mobile station estimates the current orbit position and path of two or more satellites in a satellite communication network that are expected to have potential coverage area overlapping or intersecting with the estimated mobile station path or location area. In this regard, the mobile station estimates the current orbit position and path of two or more satellites according to the description provided above for Satellite Orbit Estimator 601 of FIG. 6.

Next, in step 703, the mobile station estimates upcoming signal quality values of upcoming satellite communication links based on the estimated mobile station path and the estimated satellite paths. The mobile station estimates the signal quality values according to the description provided above for Signal Quality Estimator 607 of FIG. 6.

The process then proceeds to step 704 in which the mobile station estimates stable and unstable communication time periods based on the estimated mobile station path, the estimated satellite paths, and the estimated signal quality values. The mobile station estimates the stable and unstable communication time periods according to the description provided above for Time Period Estimator 602 of FIG. 6.

In step 705, the mobile station determines a video segment request for each of multiple estimated stable communication time periods in order to obtain sufficient video segments during each estimated stable communication time period to provide uninterrupted video playback during at least one subsequent unstable communication time period. The mobile station determines the video segment request(s) according to the description provided above for Video Segment Selector 603 of FIG. 6.

Process flow then proceeds to step 706 in which the mobile station establishes a new connection between the mobile station and a content delivery network via one of the satellites during each estimated stable communication time period associated with a video segment request and submits the video segment request over the new connection. For example, the mobile station establishes a new TCP connection between the mobile station and a content delivery network for streaming video delivery, wherein the TCP connection is conducted through communication of the mobile station with a servicing satellite during the associated stable communication time period. The TCP connection is torn down after completion of the specific video segment request, and a new TCP connection must be established for each subsequent video segment request.

In step 707, the mobile station receives video segments associated with each video segment request via each new associated connection during the associated stable communication time period and buffers the received video segments into a playback buffer. The mobile station conducts the video buffering according to the description provided above for Video Player 604 of FIG. 6.

Next, in step 708 the mobile station plays back the received video segments from the buffer during the associated estimated stable and unstable communication time periods, thereby providing continuous video playback even during unstable communication time periods during which the mobile station is not actually receiving video segments. The mobile station conducts the video playback according to the description provided above for Video Player 604 of FIG. 6.

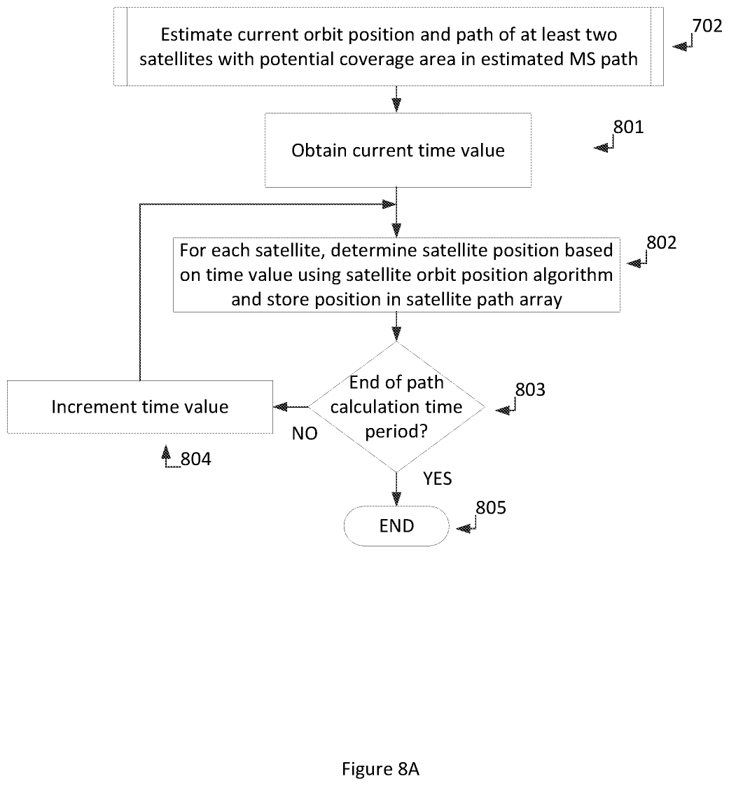

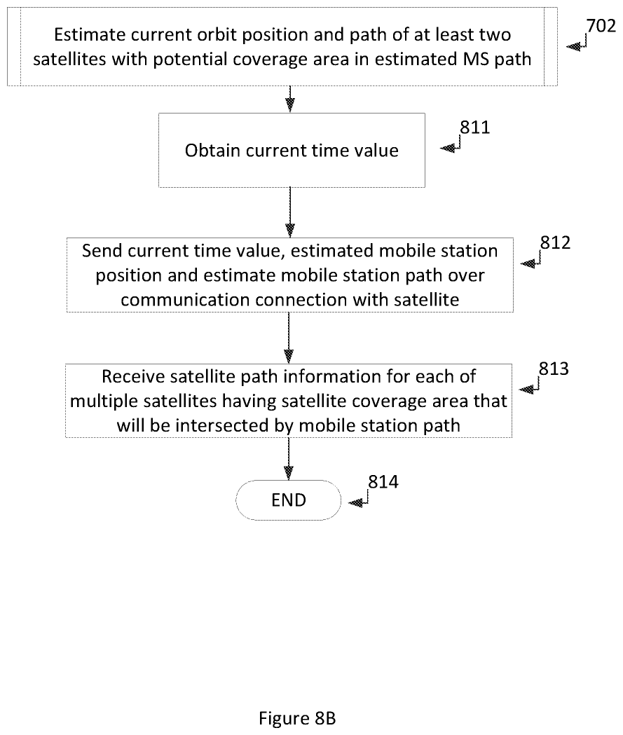

FIG. 8A is a flowchart that illustrates the estimation of orbit positions and paths of at least two satellites with potential coverage area in the estimated mobile station path according to aspects of the invention. The mobile station can conduct the estimation of satellite orbit positions and paths according to the description provided above for Satellite Orbit Estimator 601 of FIG. 6. In step 801, a current time value is obtained, such as for example from a GSM service or from communication with a satellite, or other known method. Next, in step 802, a satellite position is determined for the time value based on a satellite orbit position algorithm and then the determined satellite position is stored in association with the time value in a satellite path array or table which can be stored in memory 608 for example. The satellite orbit position algorithm may be based on a known satellite orbit equation such as:

Mean motion

$$n = \frac{2 π}{ρ} ,$$

where [symbol] is the orbital period.

In another aspect, the satellite orbit position algorithm may be a software code or a chart in which the predetermined orbit path of each satellite is provided. For example, the operator of a satellite communication network may provide such software code or chart for preloading or convenient access by a mobile station in the satellite communication network. Such code or chart may be stored in memory 608 of the mobile station, for example.

In step 803, it is determined if the end of the calculation time period has been reached, wherein the calculation time period is a predetermined amount of time for which to estimate the satellite path, such as for example the upcoming 30 minutes. If it is the end of the calculation time period, the process flow proceeds to the end of the process in step 805, upon which the estimation of the path for each satellite of interest has been completed.

If in step 803 it is not the end of the calculation time period, the process flow proceeds to step 804 in which the time value is incremented by a fixed amount (the next incremental step in the estimated satellite path) and the process flow reverts back to step 802 to determine the next incremental position in the satellite path for each satellite of interest.

FIG. 8B is a flowchart that illustrates the obtainment of orbit positions and paths of at least two satellites with potential coverage area in the estimated mobile station path according to aspects of the invention. The mobile station can conduct the estimation of satellite orbit positions and paths according to the description provided above for Satellite Orbit Estimator 601 of FIG. 6. In step 811, a current time value is obtained, such as for example from a GSM service or from communication with a satellite, or other known method. Next, in step 812, the mobile station sends the time value, the estimated mobile station position and the estimated mobile station path via the mobile station's communication connection with the currently servicing satellite. In step 813, the mobile station receives satellite position and path information for each of multiple satellites having satellite coverage area that will be intersected by the estimated mobile station path. The process then ends at step 814. For example, in this manner the mobile station may use a realtime service operated by the operator of the satellite communication network to quickly obtain upcoming satellite positions and paths of nearby satellites that the mobile station is likely to be in the coverage area of. In the alternative, the upcoming satellite positions and paths may be calculated for the mobile station by the servicing satellite, or by a ground station which is in communication with the servicing satellite and then sent to the mobile station.

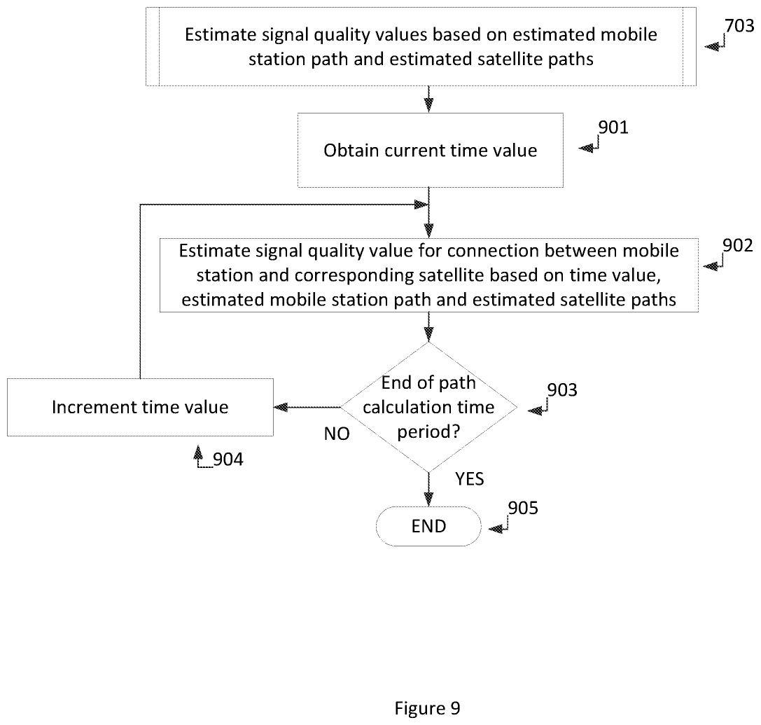

FIG. 9 is a flowchart that illustrates the estimation of signal quality values at a mobile station according to aspects of the invention. The mobile station can estimate the signal quality values according to the description provided above for Signal Quality Estimator 607 of FIG. 6. In step 901, a current time value is obtained, such as for example from a GSM service or from communication with a satellite, or other known method. Next, in step 902, a signal quality value is estimated for a communication connection between the mobile station and the corresponding satellite based on the time value, the estimated mobile station path and the estimated satellite paths. The signal quality value may also be based on past signal quality values measured by the transceiver of the mobile station when communicating with the particular satellite of interest.

In step 903, it is determined if the end of the calculation time period has been reached, wherein the calculation time period is a predetermined amount of time for which to estimate the signal quality values, such as for example the upcoming 30 minutes. If in step 903 it is the end of the calculation time period, the process flow proceeds to the end of the process in step 905, upon which the estimation of the signal quality values for the calculation time period has been completed.

If in step 903 it is not the end of the calculation time period, the process flow proceeds to step 904 in which the time value is incremented by a fixed amount (the next incremental step in the estimated satellite path) and the process flow reverts back to step 902 to determine the next signal quality value for each satellite of interest at that incremented time value.

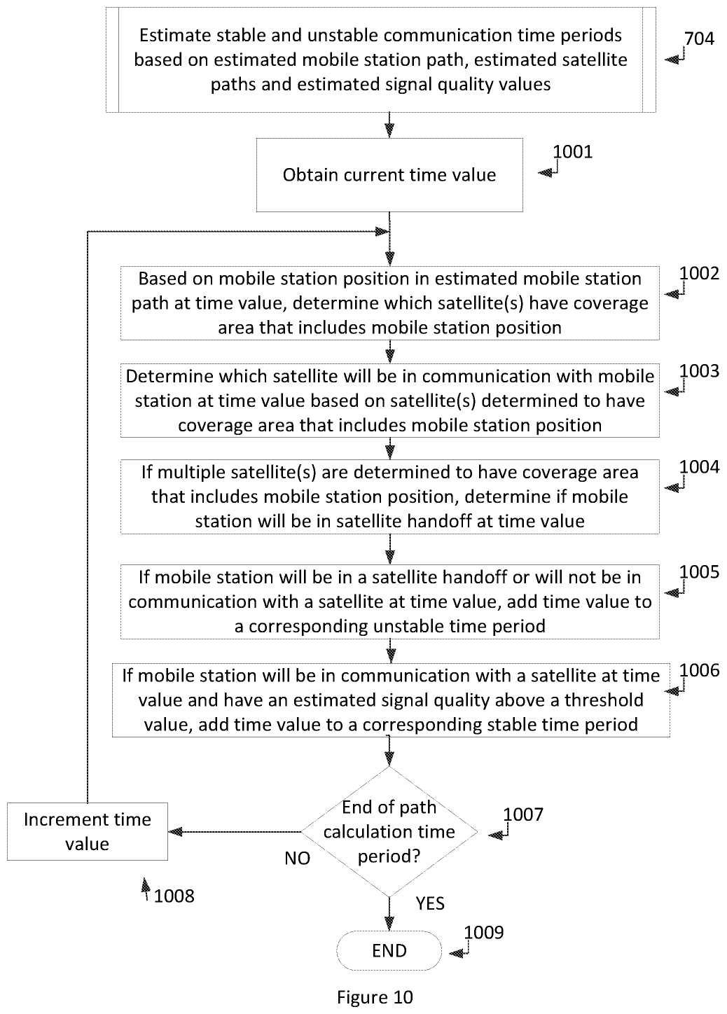

FIG. 10 is a flowchart that illustrates the estimation of stable and unstable communication time periods at a mobile station according to aspects of the invention. The mobile station can estimate the stable and unstable communication time periods according to the description provided above for Time Period Estimator 602 of FIG. 6. In step 1001, a current time value is obtained, such as for example from a GPS service or from communication with a satellite, or other known method.

Next, in step 1002, the mobile station determines which satellite(s) have coverage area that will include the mobile station position based on the mobile station position and the estimated mobile station path at the time value. In step 1003, the mobile station determines which satellite will be in communication with mobile station at the time value based on those satellite(s) determined (in step 1002) to have a coverage area that includes the mobile station position.

The process proceeds to step 1004 in which, for the situation that multiple satellite(s) are determined (in step 1003) to have coverage area that includes the mobile station position, the mobile station determines if it will be in a satellite handoff at the time value. In step 1005, if it is determined in step 1004 that the mobile station will be in a satellite handoff or will not be in communication with a satellite at the time value, the time value is added to a corresponding unstable communication time period.

In step 1006, if it is determined in steps 1003 and 1004 that the mobile station will be in communication with a satellite at the time value and will not be in a satellite handoff at the time value, and the mobile station has an estimated signal quality for that time value above a threshold value, then the time value is added to a corresponding stable communication time period.

In step 1007, it is determined if the end of the calculation time period has been reached, wherein the calculation time period is a predetermined amount of time for which to estimate the stable and unstable communication time periods, such as for example the upcoming 30 minutes. If in step 1007 it is the end of the calculation time period, the process flow proceeds to the end of the process in step 1009, upon which the estimation of the stable and unstable communication time periods for the calculation time period has been completed.

If in step 1007 it is not the end of the calculation time period, the process flow proceeds to step 1008 in which the time value is incremented by a fixed amount (the next incremental step) and the process flow reverts back to step 1002 to repeat steps 1002 through 1007 for the continued estimation of the stable and unstable communication time periods.

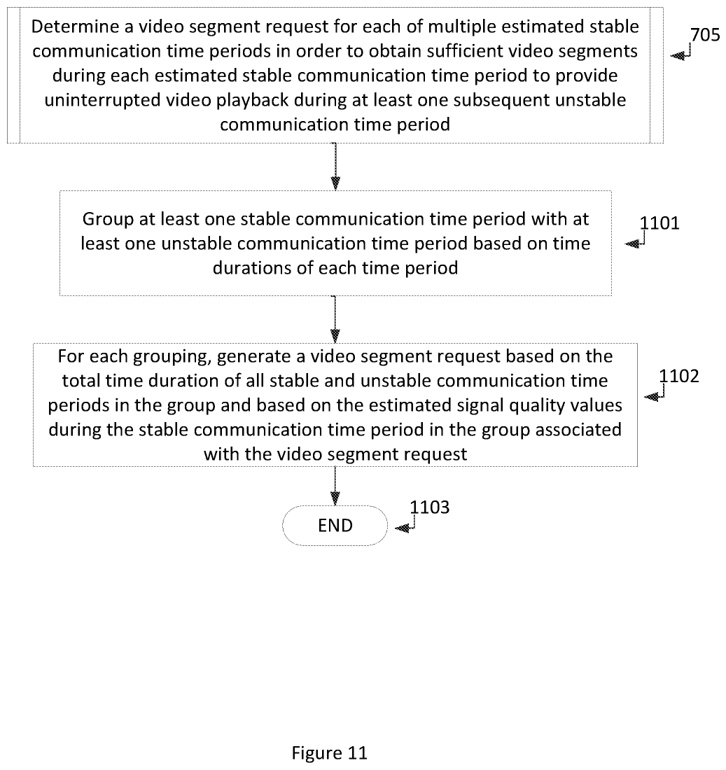

FIG. 11 is a flowchart that illustrates the determination of at least one video segment request at a mobile station according to aspects of the invention. The mobile station can determine the at least one video segment request according to the description provided above for Video Segment Selector 603 of FIG. 6. In step 1101, the mobile station groups at least one stable communication time period with at least one unstable communication time period based on time durations of each communication time period. For example, an upcoming stable communication time period may be grouped with only one or with several subsequent upcoming unstable communication time periods, so that sufficient video segments may be received by the mobile station during only the upcoming stable communication time period to maintain continuous video playback also during the associated one or several subsequent unstable communication time periods.

Next, in step 1102, for each group created in step 1101, the mobile station generates a corresponding video segment request based on the total time duration of the stable and unstable communication time periods provided in the group and also based on the estimated signal quality values during the stable communication time period in the group associated with the video segment request. The process flow then ends at step 1103.

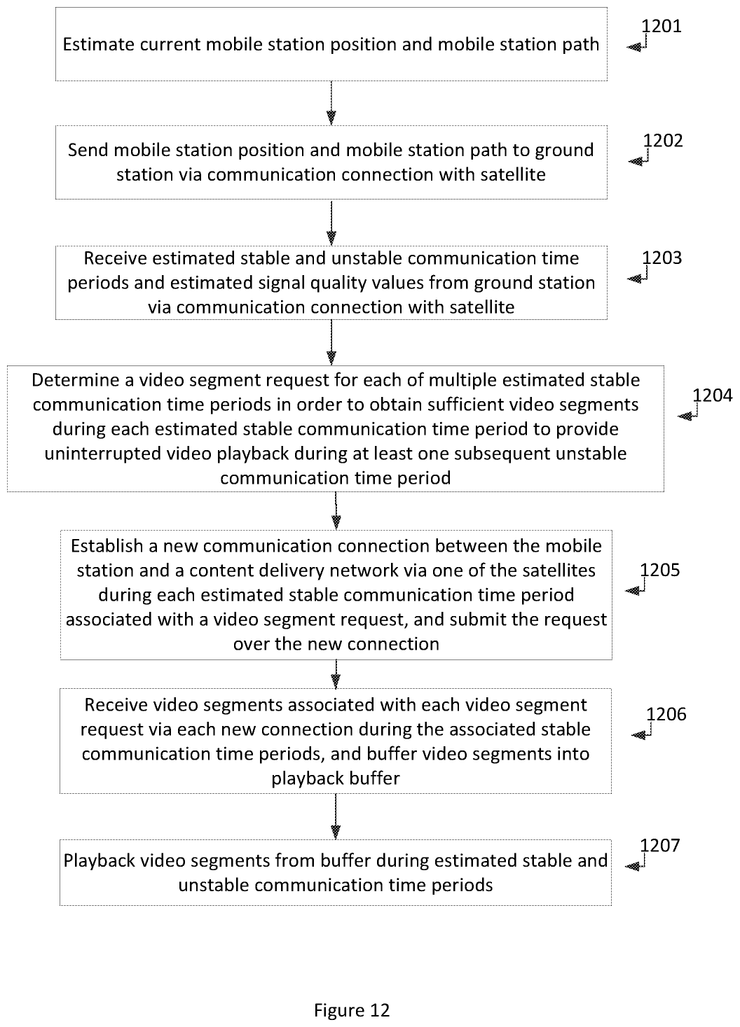

FIG. 12 is a flowchart that illustrates an alternative process performed by a mobile station for controlling delivery of video streaming to the mobile station in a satellite communication network according to aspects of the invention.

In step 1201, the mobile station (such as mobile station MS1 in previous figures) estimates its own position and an expected mobile station path and may also estimate an expected location area. The mobile station estimates its position, expected mobile station path, and expected location area according to the description provided above for Position Determiner 605 of FIG. 6.

In step 1202, the mobile station sends the estimated mobile station position and path to a ground station via a communication connection of the mobile station with a satellite. In the alternative, the mobile station sends the estimated mobile station position and path to a third-party service, such as a service offered by the operator of the satellite communication network, via a communication connection of the mobile station with a satellite (and via a ground station in communication with the satellite). This step can be performed by a communication time period manager function, which may for example be provided in Time Period Estimator 602 of FIG. 6.

In step 1203, the mobile station receives estimated stable and unstable communication time periods and estimated signal quality values from the ground station (or from the third-party service) via the communication connection of the mobile station with the satellite. The received estimated stable and unstable communication time periods and estimated signal quality values are stored in a memory of the mobile station. This step can also be performed by a communication time period manager function, which may for example be provided in Time Period Estimator 602 of FIG. 6.

In step 1204, the mobile station determines a video segment request for each of multiple estimated stable communication time periods in order to obtain sufficient video segments during each estimated stable communication time period to provide uninterrupted video playback during the stable communication time period and the at least one subsequent unstable communication time period. The mobile station determines the video segment request(s) according to the description provided above for Video Segment Selector 603 of FIG. 6.

Process flow then proceeds to step 1205 in which the mobile station establishes a new connection between the mobile station and a content delivery network via one of the satellites during each estimated stable communication time period associated with a video segment request and submits the video segment request over the new connection. For example, the mobile station establishes a new TCP connection between the mobile station and a content delivery network for streaming video delivery, wherein the TCP connection is conducted through communication of the mobile station with a servicing satellite during the associated stable communication time period. The TCP connection is torn down after completion of the specific video segment request, and a new TCP connection must be established for each subsequent video segment request.

In step 1206, the mobile station receives video segments associated with each video segment request via each new associated connection during the associated stable communication time periods, and then buffers the received video segments into a playback buffer. The mobile station conducts the video segment buffering according to the description provided above for Video Player 604 of FIG. 6.

Next, in step 1207 the mobile station plays back the received video segments from the buffer during the associated estimated stable and unstable communication time periods, thereby providing continuous video playback even during unstable communication time periods when the mobile station is not actually receiving video segments. The mobile station conducts the video playback according to the description provided above for Video Player 604 of FIG. 6.

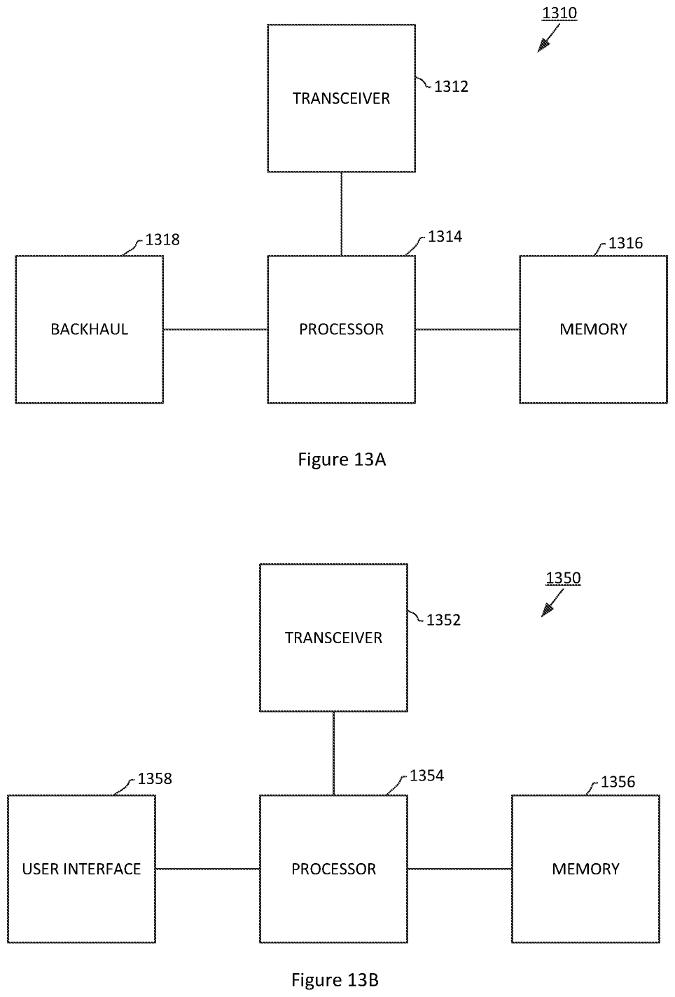

FIG. 13A is a block diagram of a base station 1310 in accordance with aspects of the invention. Base station 1310 may be a GSM base transceiver station BTS function, a WiMAX base station, a UMTS NodeB, an LTE evolved NodeB (eNodeB or eNB), or a similar functional device. In various aspects, the functionality of base station 1310 may be provided in a low earth orbit satellite such as LEO1 in a satellite communication network as shown in the previous figures. Alternatively, base station 1310 may be implemented in very low earth orbit satellites (VLEO), balloons, airplanes or any other broadband communication system implementing such a vehicle with the equivalent of a GSM base transceiver station BTS function, a WiMAX base station, a UMTS NodeB, an LTE evolved NodeB (eNodeB or eNB) or a similar function.

Base station 1310 includes a processor 1314. Processor 1314 is coupled to a transceiver (transmitter-receiver) 1312, a backhaul interface 1318, and a memory storage 1316. The transceiver 1312 is configured to transmit and receive communications wirelessly with other devices. Base station 1310 generally includes one or more antennae, in connection with transceiver 1312, for transmission and reception of radio signals. The communications of the transceiver 1312 may be with user stations, such as mobile station MS1, with other satellites, and with ground stations. Transceiver 1312, in connection with antennae, may generate a communication coverage area such as a moving coverage area on the earth's surface as the satellite containing transceiver 1312 moves along its predetermined orbital path. Transceiver 1312, in connection with antennae, may generate the communication coverage area using beamforming or other known transmission techniques and may generate multiple spot beams to make up the entire communication coverage area.

Backhaul interface 1318 provides an interface between base station 1310 and a core network, such as a core network supporting a satellite communications network. This interface may include communications via transceiver 1312 directly or indirectly with ground stations, and/or with other satellites via an inter-satellite sidelink connection. In this manner, communications received at transceiver 1312 from a mobile station, for example, may then be transmitted by backhaul interface 1318 to a core network back through transceiver 1312 or another transceiver to a ground station or through another satellite to a ground station. Similarly, communication received from the core network to the backhaul interface 1318 may then be transmitted by the transceiver 1312 to a mobile station. Although the base station 1310 of FIG. 13A is shown with a single backhaul interface 1318, other aspects may include multiple backhaul interfaces. Similarly, the base station 1310 may include multiple transceivers, and the multiple interfaces and transceivers may operate according to different communication protocols.

Processor 1314 can process communications being received and transmitted by base station 1310 via transceiver 1312 and in cooperation with backhaul interface 1318. The memory storage 1316 stores data and information for use by processor 1314. Memory 1316 may also be used to store computer readable instructions for execution by the processor 1314. The computer-readable instructions can be used by base station 1310 to accomplish the various functions of the base station 1310. In an aspect, memory 1316, or parts thereof, may be considered a non-transitory machine-readable medium. The functionality of base station 1310 may be accomplished by processor 1314 in conjunction with the memory 1316, transceiver 1312, and backhaul interface 1318. Furthermore, in addition to executing instructions, processor 1314 may include specific purpose hardware to accomplish some or all of the functions of base station 1310.

FIG. 13B is a block diagram of a mobile station 1350 in accordance with aspects of the invention. For example, mobile station 1350 may represent mobile station MS1 shown in previous figures.

Mobile station 1350 may be capable of operating in a GSM, a WiMAX, a UMTS or an LTE wireless communication network, or other known types of wireless networks or subsequently developed types of wireless networks. In various aspects, mobile station 1350 may operate in a low earth orbit (LEO) satellite communication network, such as that shown in the previous figures. Alternatively, mobile station 1350 may be implemented in a very low earth orbit satellites (VLEO) satellite communication network, a balloon-based communication network, an airplane based communication network or any other type of broadband communication system implementing vehicles with the equivalent of a GSM base transceiver station BTS function, a WiMAX base station function, a UMTS NodeB function, an LTE evolved NodeB (eNodeB or eNB) function or a similar function.

Mobile station 1350 includes a processor 1354, which is coupled to a transceiver (transmitter-receiver) 1352, a user interface 1358, and a memory storage 1356. The transceiver 1352 is configured to transmit and receive communications wirelessly with other devices. Mobile station 1350 generally includes one or more antennae, in connection with transceiver 1352, for transmission and reception of radio signals. The communications of the transceiver 1352 may be with base stations in satellites and also with ground stations. Transceiver 1352, in connection with antennae provided in mobile station 1350 communicate with a satellite, for example, within a communication coverage area of the satellite, such as a moving coverage area on the earth's surface as the satellite moves along its predetermined orbital path. Such a communication coverage area may be a single satellite coverage area or may consist of multiple spot beams generated by the satellite to make up the entire communication coverage area.

Processor 1354 can process communications being received and transmitted by mobile station 1350 via transceiver 1352. Memory 1356 stores data and information for use by processor 1354. Memory 1356 may also be used to store computer readable instructions for execution by processor 1354. The computer-readable instructions can be used by mobile station 1350 to accomplish the various functions of mobile station 1350. In an aspect, memory 1356, or parts thereof, may be considered a non-transitory machine-readable medium. The functionality of mobile station 1350 may be accomplished by processor 1354 in conjunction with the memory 1356, transceiver 1352, and user interface 1358. Furthermore, in addition to executing instructions, processor 1354 may include specific purpose hardware to accomplish some or all of the functions of mobile station 1350.

User interface 1358 includes devices, modules and/or functionality for communicating and interfacing with a user of mobile station 1350. User interface 1358, in aspects, includes a speaker and a microphone for audio communications with the user, a video screen for providing visual information, including video playback, to the user, and a keypad for accepting alphanumeric commands and data from the user. In some aspects, a touch screen may be used in place of or in combination with the keypad and the video screen to allow graphical inputs in addition to alphanumeric inputs and to display graphic pages, pictures, and playback video. User interface 1358 may have other configurations and include other modules, functions and/or devices such as vibrators, cameras, sensors, and lights.

### Communication Handover Management

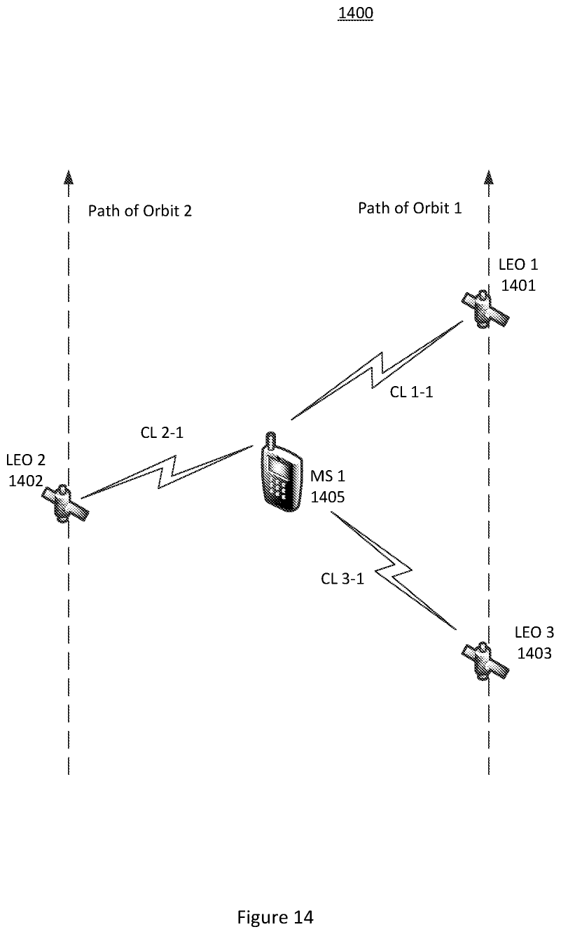

When a mobile station can communicate with multiple satellites simultaneously, it must make decisions regarding which satellites to communicate with in order to reach the internet, private networks, and the rest of the world. FIG. 14 shows a scenario where a mobile station may make tradeoffs between minimizing handovers from satellite to satellite, in turn minimizing the unstable communication periods described above, and maximizing signal quality and, therefore, communication link capacity and communication network capacity.

Referring to FIG. 14, if mobile station MS1 1405 can communicate with satellite LEO3 1403 before losing communication with satellite LEO1 1401, it must decide based on tradeoffs between signal quality and frequency of unstable periods whether or not to handoff to satellite LEO2 1402 for a time before handing off to satellite LEO3 1403.

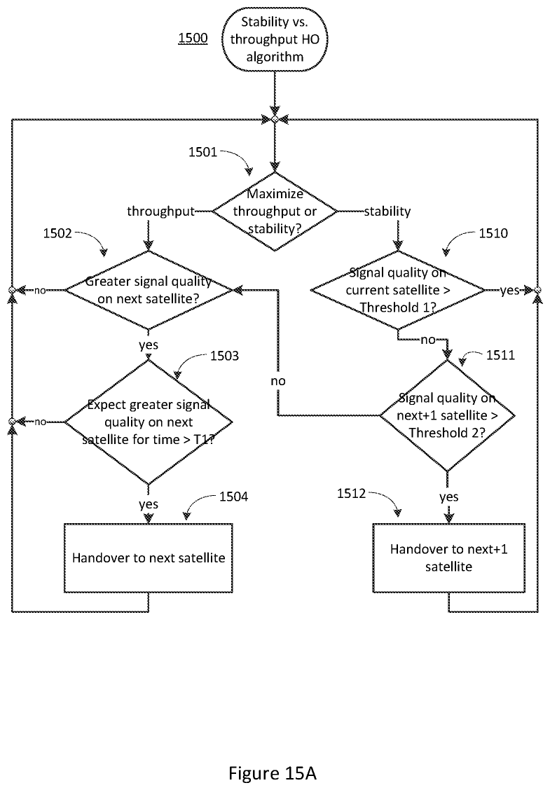

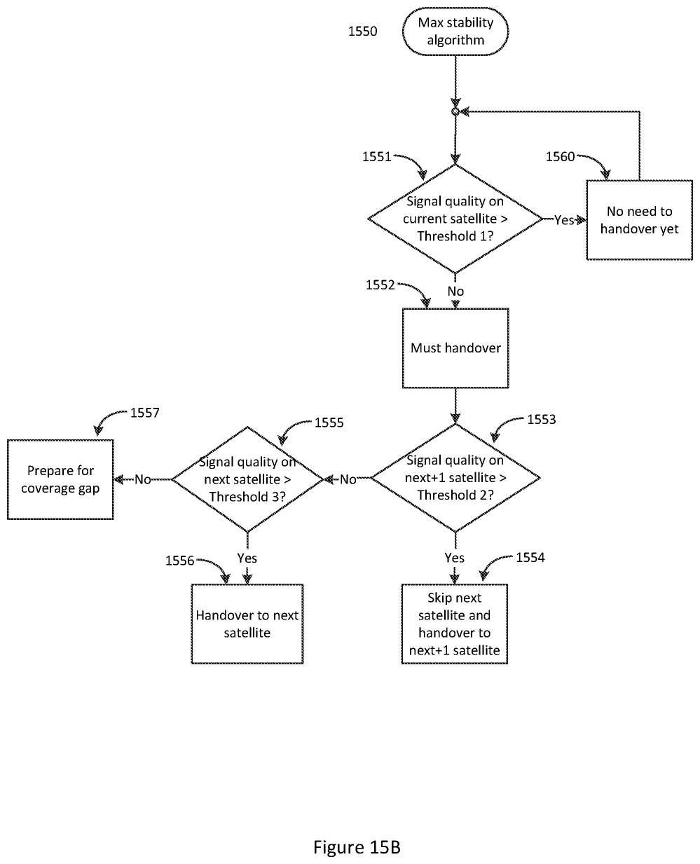

An example embodiment of the method to choose the satellite to handover to next is described in more detail with respect to FIG. 15A. In FIG. 15A, for ease of explanation of embodiments, the current satellite may represent satellite LEO1 1401 of FIG. 14, the next satellite may represent satellite LEO2 1402 of FIG. 14, and the next+1 satellite may represent satellite LEO3 1403 of FIG. 14.

The handover management process 1500 depicted in FIG. 15A may be used by mobile stations such as mobile station MS1 to trade off stability of communications links versus handover frequency, and, therefore, the frequency and duration of unstable communication periods when deciding which satellite to handover to. A mobile station may be configured to conduct handoff management to maximize throughput, or to maximize stability, or may alternate between these two. For instance, a mobile station may choose to maximize stability while streaming video but may choose to maximize throughput while only low QoS services are operating.

At decision step 1501, the mobile station determines whether it is currently maximizing throughput or stability. If it is maximizing throughput, it continues to decision step 1502. Note that for a mobile station that is configured to always maximize throughput it could use a simplified version of method 1500 comprised of steps 1502, 1503 and 1504. At step 1502 the mobile station determines whether the signal quality communicating with the next satellite, for instance LEO2, is greater than the signal quality communicating with the current satellite, for instance LEO1. If the signal quality is still greater communicating with the current satellite, for instance LEO1, the method returns to step 1501. If the signal quality for communicating with the next satellite, for instance LEO2, is greater than the signal quality for communicating with the current satellite, for instance LEO1, the method proceeds to decision step 1503. At decision step 1503, if the signal quality is expected to be greater for communicating to the next satellite, for instance satellite LEO2, for a time duration greater that T1, then the mobile station hands over to the next satellite, for instance satellite LEO2, at step 1504. before returning to step 1501. Otherwise, the process returns to decision step 1501 without handing over.

Note that decision step 1503 can be optional, for instance in the case where handover to the next satellite of greater communication link quality always occurs. This may be the case when, for instance, the mobile station would lose connectivity with the current satellite, for instance LEO1, before being able to achieve connectivity with the next+1 satellite, for instance LEO3. Optionality of step 1503 may be achieved by removing step 1503 or by setting parameter T1 to a value less than or equal to 0 (zero) time units (for example milliseconds). Step 1503 can include more detail and can include more or different types of decision logic than shown in FIG. 15. For instance, the condition may include determining whether a satellite next+1 is expected to be available for service prior to losing communication with the current satellite. If that is not the case, handover to the satellite may be necessary even if the time duration of good signal quality is less than desired.

If at decision step 1501, the mobile station is currently maximizing stability, the method proceeds to decision step 1510. At decision step 1510, the mobile station determines whether the signal quality for communicating with the current satellite, for instance LEO1, is greater than Threshold 1. If it is, then the mobile makes no attempt to handover to any other satellite and the process returns to decision step 1501. If, however, at decision step 1510 the mobile station determines that the signal quality for communicating with the current satellite, for instance LEO1, has fallen below Threshold 1 then the mobile station must consider handing over to another satellite, and the method proceeds to decision step 1511. In an embodiment Threshold 1 may be varied, for instance if the mobile station is moving at a high velocity or the signal quality for communicating with the current satellite is varying rapidly, Threshold 1 may be set to a higher level, causing handover sooner, than if the mobile station was stationary with slowly changing signal quality. At decision step 1511 the mobile station determines whether the signal quality for communicating with the next+1 satellite, for instance satellite LEO3, is greater than Threshold 2. If it is not, there is a risk that the handover to satellite next+1, for instance LEO3, will fail. In this case, an extra handover to the next satellite, for instance satellite LEO2, may be more stable than handing over to the next+1 satellite, for instance satellite LEO3, and the method proceeds to decision step 1502 at which point the method proceeds as described above. If at decision step 1511 the mobile station determines that the signal quality for communicating with the next+1 satellite, for instance satellite LEO3, is greater than Threshold 2, the method proceeds to step 1512 where the mobile station performs a handover to satellite next+1, for instance LEO3. The method then returns to decision step 1501. Threshold 2 may be dynamic. For instance, if a mobile station configured to maximize stability currently has no streaming video services or other services that would be impacted by unstable communications periods, Threshold 2 could be decreased causing a temporary shift towards favoring throughput by causing the method to follow the path from decision step 1511 to decision step 1502 more often.

FIG. 15B depicts a handover management process 1550 that may be used by mobile stations such as a mobile station MS1 to maximize stability of communications links for mobile station MS1.

At decision step 1551, the mobile station determines whether the signal quality for communicating with the current satellite, for instance LEO1, is greater than Threshold 1. If it is, then the process proceeds to step 1560 in which the mobile station does not handover to another satellite and the process proceeds back to decision step 1551. If, however, at decision step 1551 the mobile station determines that the signal quality for communicating with the current satellite, for instance LEO1, is equal to or below Threshold 1 then the mobile station proceeds to step 1552 in which the mobile station must consider handing over to another satellite. In an aspect, Threshold 1 may be varied, for instance if the mobile station is moving at a high velocity or the signal quality for communicating with the current satellite is varying rapidly, Threshold 1 may be set to a higher level, causing handover sooner, than if the mobile station was stationary with slowly changing signal quality.

At decision step 1553, the mobile station determines whether the signal quality for communicating with the next+1 satellite, for instance satellite LEO3, is greater than Threshold 2. If it is not, there is a risk that the handover to satellite next+1, for instance LEO3, will fail or will result in an inadequate communication link for the mobile station. In this case, an extra handover to the next satellite, for instance satellite LEO2, may be more stable than handing over to the next+1 satellite, for instance satellite LEO3, and the process proceeds to decision step 1555 in which the mobile station determines whether the signal quality for communicating with the next satellite, for instance satellite LEO2, is greater than Threshold 3. If the signal quality for communicating with the next satellite is greater than Threshold 3 then the process proceeds to step 1556 at which the mobile station conducts a communication handover to the next satellite, such as LEO2. If the signal quality for communicating with the next satellite is not greater than Threshold 3 then the process proceeds to step 1557 at which the mobile station prepares for a communication coverage gap because at this point it has been determined that none of the current satellites (such as LEO1), the next+1 satellite (such as LEO3) and the next satellite (such as LEO2) have a communication link capability with an adequate signal quality for the mobile station.

If, at decision step 1553, the mobile station determines that the signal quality for communicating with the next+1 satellite, for instance satellite LEO3, is greater than Threshold 2, the process proceeds to step 1554 in which the mobile station conducts a communication handover to the next+1 satellite, such as LEO3. In this manner, the mobile station maximizes communication stability by only handing over to another satellite if it will provide a communication link with sufficient signal quality and the mobile station attempts to minimize the number of handovers by skipping a next satellite in the path of mobile station if the next+1 satellite can provide a communication link with sufficient signal quality.

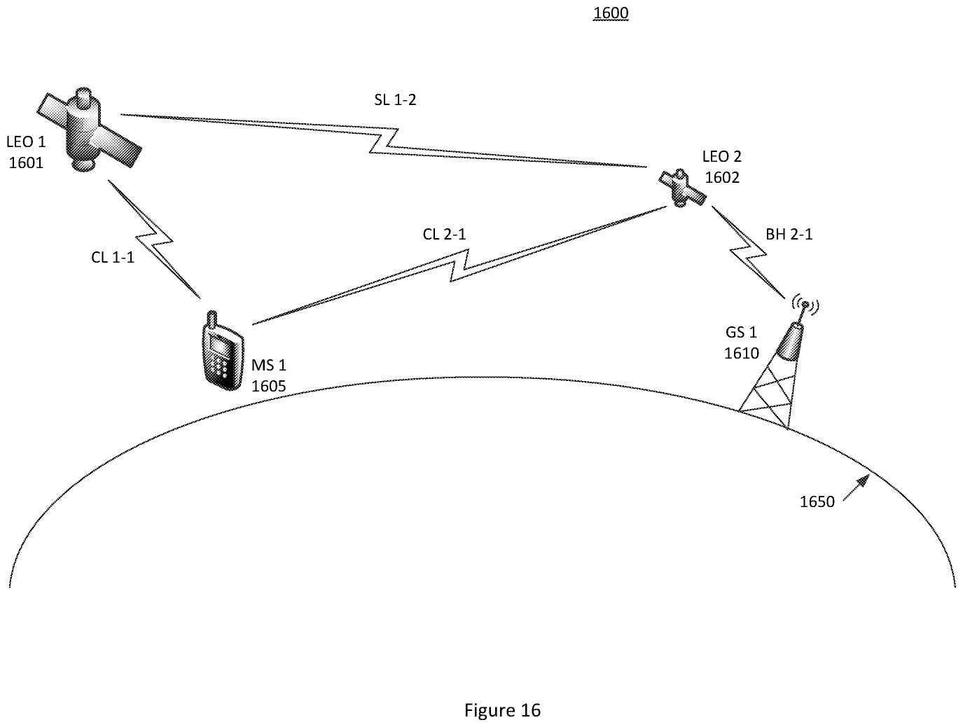

There are numerous situations known to one skilled in the art that can degrade the signal quality between a mobile station and a satellite. For instance, increased distance between the mobile station and the satellite attenuates the received signal. Also, the angle between the mobile station and the satellite, for instance if the satellite is on the horizon versus directly overhead, can have a significant impact on signal strength and quality. This is especially true if the satellite has, possibly steerable, spot beams or if the mobile station is at the base of an obstruction such as a building our hill. This in turn reduces the data carrying capacity of the communications link between the mobile station and the satellite. For instance, FIG. 16 depicts a situation in which the distance from satellite LEO1 1601 to mobile station MS1 1605 is shorter than the distance from satellite LEO2 1602 to mobile station MS1 1605. One skilled in the art would understand that the received signal strength indication (RSSI), signal to noise ratio (SNR), carrier to interference plus noise ratio (CINR), and other well know signal quality metrics will be indicative of a better signal when measured for communication link CL1-1 between mobile station MS1 1605 and satellite LEO1 1601 than when measured for communication link CL2-1 between mobile station MS1 1605 and satellite LEO2 1602. In this case, communications link CL1-1 would likely have a higher data carrying capacity, or bandwidth, than communications link CL2-1.

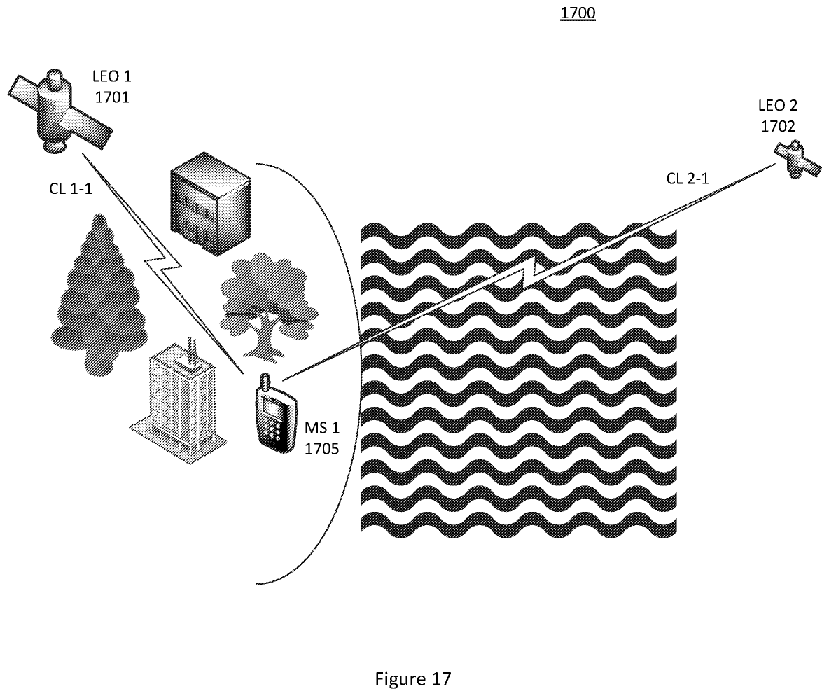

Turning to FIG. 17, if obstructions such as buildings and trees impair the path of the signals between mobile station MS1 1705 and satellite LEO1 1701, the communications link CL1-1 can be attenuated. If there are no obstructions to impair the path of the signals between mobile station MS1 1705 and satellite LEO2 1702, for instance if the path is over open water as shown in FIG. 17, communications link CL2-1 would not be attenuated by obstructions. In this case, the attenuation of communication link CL1-1 due to obstructions may be greater than the attenuation added by the greater distance traversed by communication link CL2-1. In that case, communication link CL2-1 would have greater data carrying capacity than communication link CL1-1.

Additionally, data traffic congestion may affect data carrying capacity from the point of view of an individual mobile station such as mobile station MS1 1705. For instance, if many other mobile stations were in communication with satellite LEO1 1701, while the theoretical physical data carrying capacity of communication link CL1-1 may be greater than the theoretical physical data carrying capacity of communication link CL2-1, the available data carrying capacity of communication link CL2-1 may be greater than the available data carrying capacity of communication link CL1-1.

In these scenarios, the communication link with the greatest data carrying capacity may have greater delay. For instance, with reference back to FIG. 16, satellite LEO2 1602 has direct communication to ground station GS1 1610 via backhaul BH2-1 but, satellite LEO1 1601 does not have direct communication with a ground station. Satellite LEO1 1601 accesses ground station GS1 1610 by relaying its data to satellite LEO2 1602 via sidelink SL1-2. Satellite LEO2 1602 then forwards data from satellite LEO1 1601 to ground station GS1 1610 via backhaul BH2-1. In this example, while communication link CL1-1 may have higher data carrying capacity than communication link CL2-1, the path from mobile station MS1 1605 over communication link CL1-1 to satellite LEO1 1601 then over sidelink SL1-2 to satellite LEO2 1602 and finally over backhaul BH2-1 to ground station GS1 1610 has a longer delay than the path from mobile station MS1 1605 over communication link CL2-1 to LEO2 1602 and then over backhaul BH2-1 to ground station GS1 1610.

Returning to FIG. 17, the communication path from MS1 1705 to LEO1 1701 has obstructions while the communication path from MS1 1705 to LEO2 1702 is over open water. In this case, even though LEO1 1701 is closer to MS1 1705 and at a better angle, the signal strength or signal communication quality between MS1 1705 and LEO2 1702 may be better than the signal strength or signal communication quality between MS1 1705 and LEO1 1701. However, satellite LEO1 1701 may be in direct communication with a ground station (not shown in FIG. 17), since it is over land while satellite LEO2 1702 may not be in direct communication with a ground station since it is over open water, for instance the ocean. Satellite LEO2 1702 may need to relay its communications with mobile station MS1 1705 through another satellite (not shown in FIG. 17) to a ground station (not shown in FIG. 17). Therefore, communication via communication link CL2-1 will have more delay than communication via communication link CL1-1.

In general, if data is tolerant to delay, it is preferable to choose a communication link based on maximizing the link and network capacity. However, for delay intolerant data the communication link may be chosen based upon minimizing delay.

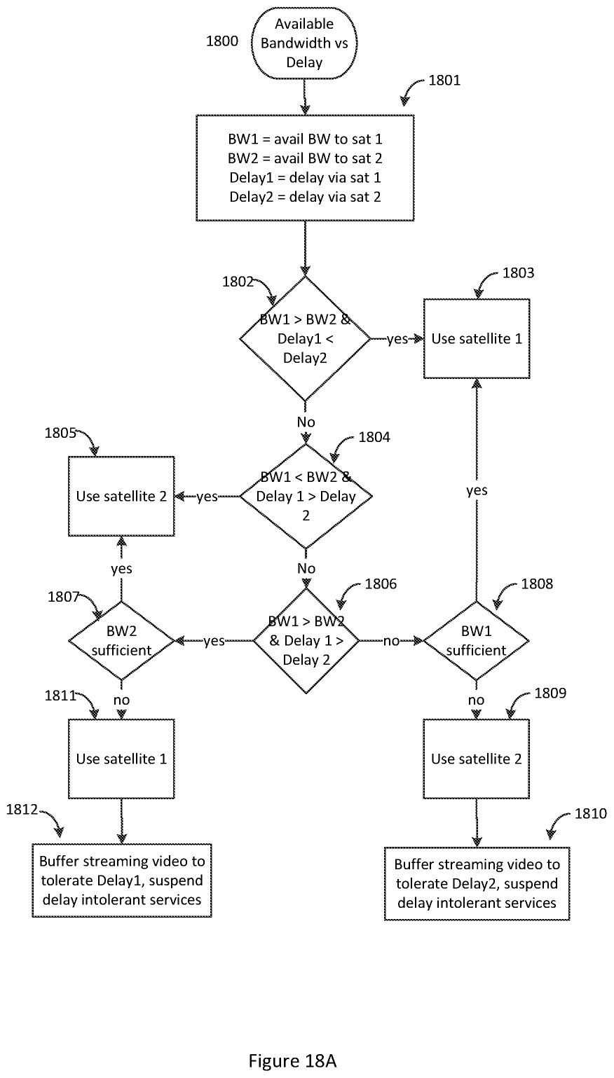

A handover management process based on available bandwidth and communication delay is illustrated in FIG. 18A.

Process 1800 of FIG. 18A may be used by a mobile station to choose between two satellites based upon tradeoffs between data throughput capacity (i.e. bandwidth) and communication delay. At step 1801, the mobile station determines the bandwidth available for communicating on the communications link to satellite 1 and on the communications link to satellite 2, for instance LEO1 and LEO2. Also, at step 1801, the mobile station determines the delay attributable to communicating through satellite 1 and through satellite 2. The process then proceeds to decision step 1802.

At decision step 1802, if the bandwidth for communicating with satellite 1 is greater than the bandwidth for communicating with satellite 2 and the delay attributable for communicating through satellite 1 is less than the delay attributable for communicating through satellite 2, then satellite 1 is the better choice by both metrics. In this case, the process proceeds to step 1803 where the mobile station selects satellite 1, for instance LEO1. If it is not the case at step 1802 that the bandwidth for communicating with satellite 1 is greater than the bandwidth for communicating with satellite 2 and the delay attributable for communicating through satellite 1 is less than the delay attributable for communicating through satellite 2, then the process proceeds to decision step 1804.

At decision step 1804, if the bandwidth for communicating with satellite 1 is less than the bandwidth for communicating with satellite 2 and the delay attributable for communicating through satellite 1 is greater than the delay attributable for communicating through satellite 2, then satellite 2 is the better choice by both metrics. In this case, the process proceeds to step 1805 where the mobile station selects satellite 2, for instance LEO2. If it is not the case at step 1804 that the bandwidth for communicating with satellite 1 is less than the bandwidth for communicating with satellite 2 and the delay attributable for communicating through satellite 1 is greater than the delay attributable for communicating through satellite 2, then the process proceeds to decision step 1806.

At decision step 1806, if the bandwidth for communicating with satellite 1 is greater than the bandwidth for communicating with satellite 2 and the delay attributable for communicating through satellite 1 is greater than the delay attributable for communicating through satellite 2, then the process proceeds to decision step 1807. At decision step 1807, if the bandwidth available for communicating via satellite 2 is sufficient (such as greater than a threshold) the process proceeds to step 1805 in which satellite 2, for instance LEO2, is chosen for a communication handover. If, at decision step 1807, the bandwidth available for communicating via satellite 2 is not sufficient then the process proceeds to step 1811 in which satellite 1, for instance LEO1, is chosen for a communication handover. The process then proceeds to step 1812 in which services operating on the mobile station such as streaming video that have buffering to make them tolerant to a certain amount of network delay, for instance 30 seconds, and jitter may perform additional buffering to make them tolerant to a larger delay, for instance 45 seconds, to compensate for the added delay attributable to communicating via satellite 1. Services operating on the mobile station that are completely intolerant of the delay attributable to communicating via satellite 1, for instance real-time video conferencing, may be suspended.

If instead, at decision step 1806, the bandwidth for communicating with satellite 1 is less than the bandwidth for communicating with satellite 2 or the delay attributable for communicating through satellite 1 is less than the delay attributable for communicating through satellite 2, then the process proceeds to decision step 1808. At decision step 1808, if the bandwidth available for communicating via satellite 1 is sufficient (such as being greater than a threshold) the process proceeds to step 1803 in which satellite 1, for instance LEO1, is chosen for a communication handover. If, at decision step 1808, the bandwidth available for communicating via satellite 1 is not sufficient then the process proceeds to step 1809 in which satellite 2, for instance LEO2, is chosen for a communication handover. The process then proceeds to step 1810 in which services operating on the mobile station such as streaming video that have buffering to make them tolerant to a certain amount of network delay, for instance 30 seconds, and jitter may perform additional buffering to make them tolerant to a larger delay, for instance 45 seconds, to compensate for the added delay attributable to communicating via satellite 2. Services operating on the mobile station that are completely intolerant of the delay attributable to communicating via satellite 2, for instance real-time video conferencing, may be suspended.

FIG. 18B illustrates a process 1850 that may be used by a mobile station to choose between two satellites based upon tradeoffs between data throughput capacity (i.e. bandwidth) and communication delay. At step 1851, the mobile station determines the bandwidth available for communicating on a communications link to satellite 1 and on a communications link to satellite 2, for instance LEO1 and LEO2. Also, at step 1851, the mobile station determines the delay attributable to a communications link to satellite 1 and the delay attributable to a communications link to satellite 2. The process then proceeds to decision step 1852.

At decision step 1852, it is determined if both the available bandwidth for communicating with satellite 1 and the available bandwidth for communicating with satellite 2 are sufficient, such as being greater than a threshold, and if so then the process proceeds to step 1853. At step 1853, it is determined if both the delay for communicating with satellite 1 and the delay for communicating with satellite 2 are tolerable, such as being below a threshold. If so, then the process proceeds to step 1854 in which the mobile station may select either satellite 1 or satellite 2 for a communication handover. If at step 1853 it is determined that the delay for communicating with satellite 1 and the delay for communicating with satellite 2 are not both tolerable (such as if one or both of the delays is above a threshold) then the process proceeds to step 1856, in which the mobile station selects for a communication handover the one of satellite 1 and satellite 2 that has the lowest delay, and the process then proceeds to step 1857 in which services operating on the mobile station are adjusted to accommodate for the delay of the selected satellite, if necessary.

If at decision step 1852 it is determined that the available bandwidth for communicating with satellite 1 and the available bandwidth for communicating with satellite 2 are not both sufficient, such as one or both of the available bandwidths being below a threshold, then the process proceeds to step 1855. In step 1855, the mobile station selects for a communication handover the one of satellite 1 and satellite 2 that has the highest available bandwidth, and the process then proceeds to step 1857 in which services operating on the mobile station are adjusted to accommodate for the delay of the selected satellite, if necessary.

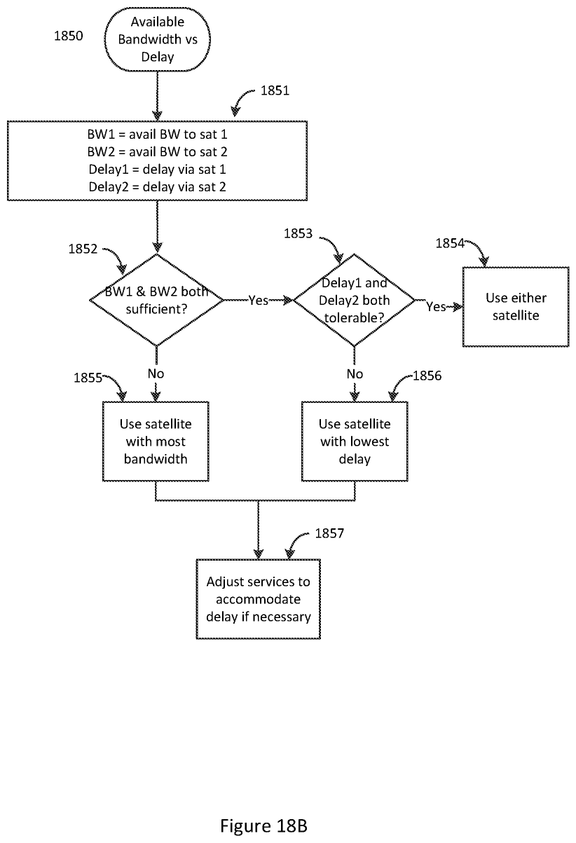

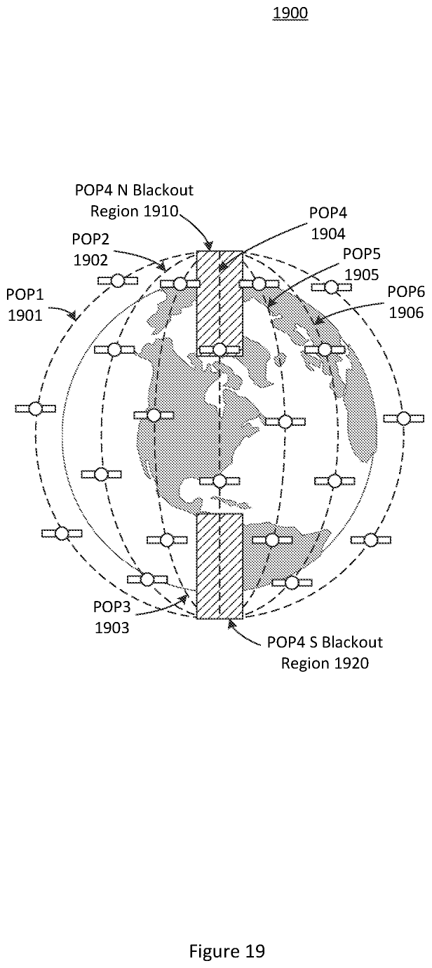

FIG. 19 shows an example of when a satellite may intentionally incur a blackout or gap in service. For constellations that use many orbits with satellites following polar orbit paths, the satellite coverage paths become quite close geographically when near the poles (or other concentration point depending upon orbital parameters). Due to spectrum limitations, if all satellites operated in these geographic regions, it would cause considerable interference and degrade communication. Therefore, it may be beneficial for certain satellites to refrain from operating when near these points of concentration. For instance, as shown in FIG. 19, satellites following polar orbit path POP4 1904 may stop providing service when in POP4 N Blackout Region 1910 and POP4 S Blackout Region 1920. In using the herein described processes to choose a satellite through which to communicate, a mobile station determines that when a satellite is in one of its designated blackout regions its available data carrying capacity or bandwidth is effectively zero regardless of its theoretical physical data carrying capacity.

One skilled in the art will understand that a similar situation would occur when a satellite flies over a country where it is not licensed to operate. In that case, as well, the satellite's available data carrying capacity or bandwidth is effectively zero regardless of its theoretical physical data carrying capacity.

The tradeoffs described herein may be made independently or simultaneously by a mobile station when deciding when and to which satellite it should handover.

A handover path is defined as the set of satellites to which a mobile station may connect via a communication link and the order in which it may connect to them in order to provide communication connectivity service for the mobile station. For example, with reference back to FIG. 14, two paths may be considered for the mobile station:

Path1: LEO1 to LEO3; and

Path2: LEO1 to LEO2 to LEO3.

In an aspect, each handover in a handover path may be associated with a cost metric. A cost may include one or more terms which describe the desirability or lack of desirability of handover to a particular satellite. A cost may include the effect of the handover as well as the effect of service via a communication link by the new serving satellite.

In an aspect, handover decisions may be based upon the minimization of the cost associated with two or more possible handover paths for the mobile station.

The cost may be a function which includes the effect of interrupted connectivity, degraded throughput, risk of lost packets, degradation of signal quality, likelihood of multipath degradation or other effects which may impact communication service quality or reliability at the mobile station.

The cost function may include one or more cost terms or metrics weighted by coefficients used to normalize units of measure, designate the relative importance of the effect or both. For example, in situations when stability of the mobile station's communication connection is more important than throughput or system capacity, a cost function may apply a larger coefficient to a term related to the length of an unstable communication period and a smaller term related to the predicted signal strength.

A cost function and, more specifically, its coefficients may be modified based on current operating conditions (of the mobile station and the network), operator policy and/or subscription service level agreements (SLAs) associated with services operating on the mobile station.

In an example, a cost function describes the handover cost from moving communication service of the mobile station from LEO1 to LEO2. The cost function includes a term related to the duration of unstable communication, a term related to signal quality, a term related to bandwidth availability and a term related to communication delay as follows:

Cost_{LEO1,LEO2}=a₁₂*T₁₂+b₁₂/Q₁₂+c₁₂/BW₁₂+d₁₂*De₁₂ (Eq. 1)

wherein:

T₁₂ is a metric for the duration of the unstable communication during handover from LEO1 to LEO2;

Q₁₂ is a metric for the communication signal quality between MS1 and LEO2;

BW₁₂ is a metric for the bandwidth, or data carrying capacity, available between MS1 and LEO2;

De₁₂ is a metric for the communication delay attributable for communicating via satellite LEO2; and

a₁₂, b₁₂, c₁₂, and d₁₂ are relative weights.

Note that some of the metrics, such as T₁₂, are multiplied by their relative weights and some, such as Q₁₂, are divided into their respective weights. This is to indicate that it is desirable to minimize the duration of unstable communication and, therefore, its metric T₁₂ so the cost function increases as it increases. Similarly, it is desirable to maximize communication signal quality and, therefore, its metric Q₁₂ so the cost function decreases as it increases. One skilled in the art would understand that the metrics could be designed to all be multiplicative, and that the metrics may be designed to account for mathematical relationships that must be accounted for before use in a cost function. For instance, in wireless communication it is possible to have some signal quality metrics ranging from positive to negative values, thereby crossing zero. Dividing by zero in EQ. 1 above would result in an infinite cost which would not necessarily be correct. In such a case metric Q₁₂ may be adjusted to be in a range that provides a realistic cost relative to the measured signal quality.

In an aspect, the metrics are predicted based on known paths of the satellites with respect to the mobile station or based on previous measurements. The relative weights may be precalculated or may be learned. A cost function may use more or fewer cost terms or metrics. Some cost terms or metrics may be related. For instance, communication signal quality Q₁₂ is related to bandwidth BW₁₂ in that greater signal quality allows the use of higher order modulations which allows greater bandwidths. However, bandwidth may also be a function of competition with other mobile stations for satellite resources. Similarly, the achievable modulation (or physical layer bit rate) may be a cost term or metric. Some cost terms or metrics, such as signal quality may follow smoothly changing curves while others such as modulation and therefore bandwidth may have a step function as the signal quality transitions across a threshold allowing operation at one modulation versus another.

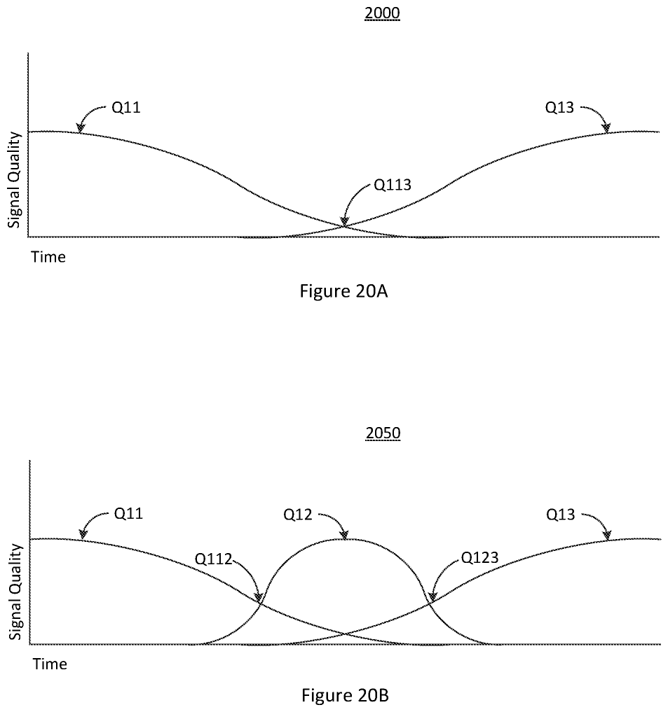

Using signal quality metric as an example, FIGS. 20A and 20B show a variety of ways that a metric may be determined.

In an aspect, FIG. 20A shows the signal quality metrics expected over time for handover PATH1 (LEO1 to LE03) above and FIG. 20B shows the signal quality metrics expected over time for handover PATH2 (LEO1 to LEO2 to LE03) above. In addition to the communication signal quality for communicating with an individual satellite, the figures also show the crossover points where communication quality with a second satellite becomes better than communication quality with a first satellite. For instance, in FIG. 20A, point Q₁₁₃ shows the crossover point where communication signal quality from mobile station MS1 to satellite LEO3 is now better than communication signal quality between mobile station MS 1 and satellite LEO1. Similarly, in FIG. 20B, point Q₁₁₂ shows the crossover point where communication signal quality from mobile station MS1 to satellite LEO2 is now better than communication signal quality between mobile station MS1 and satellite LEO1, and point Q₁₂₃ shows the crossover point where communication signal quality from mobile station MS1 to satellite LEO3 is now better than communication signal quality between mobile station MS1 and satellite LEO2.

The metric used in the cost function for handing over from one satellite to another or for a handover path may be defined in a variety of ways. For instance, Q₁₂ of EQ. 1 above may be defined as the lowest possible communication quality. For the example in FIG. 20B this would be the communication quality at point Q₁₁₂. One skilled in the art would understand that many other methods may be used for determining or defining metric Q₁₂ for EQ. 1. For instance, the average value of metric Q₁₂ between crossover points Q₁₁₂ and Q₁₂₃ may be used. A handover or handover path cost function may have more than one term associated with signal quality. For instance, it may have a term that is based upon the minimum signal quality and a second term that is based upon the average signal quality.

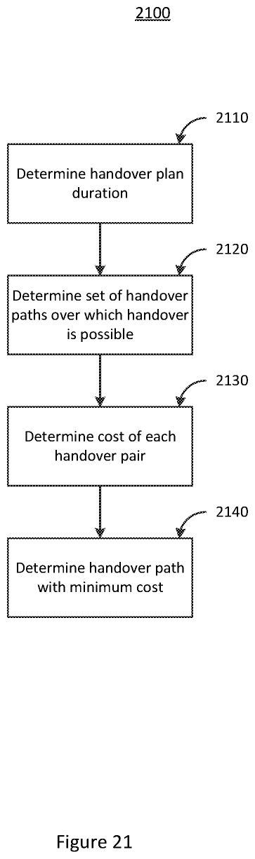

FIG. 21 shows an exemplary handover management process 2100.

In step 2110 of process 2100 shown in FIG. 21, a handover plan duration is determined. This is a time horizon over which handovers are planned for the mobile station. This may be a fixed time duration, for example 1 hour. Alternatively, this may be a dynamic time duration that depends on current network and mobile station conditions. For example, if a mobile station is in motion, the handover plan duration may be reduced to 15 minutes in order to account for the limited ability to predict future coverage conditions due to changes in location.

Next, in step 2120, all potential satellites which may serve the mobile station over the handover plan duration are determined and all possible handover paths are then determined based on the determined potential satellites. This step may be aided by knowledge of the current mobile station position and the projected paths and coverage areas of satellites in the satellite network during the handover plan duration.

The process proceeds to step 2130, in which a cost is determined for each potential handover between two potential satellites that may provide service during the handover plan duration. The cost may be based on current measurements and conditions (e.g. current position, current network load, current amount of observable sky), historical measurements (e.g. known LEO orbits, network load variations over time) and future projections (projected mobile station position, projected network load, projected amount of observable sky). The cost function may include one or more parameters related to service reliability (e.g. duration of unstable communication), service quality (e.g. predicted signal level) or system operation (e.g. system capacity, signaling overhead).

Then, in step 2140, a handover path is determined based on the minimization of total cost across each possible handover path. In one aspect in which only several different handover paths (such as five or fewer handover paths) are possible for the mobile station over the handover plan duration, the total cost over each handover path is calculated and then the handover path with the least cost is selected. In another aspect in which a large number of different handover paths are possible for the mobile station over the handover plan duration, a known weighted path search algorithm can be used to identify the lowest cost handover path between the current serving satellite and one or more satellites which may provide service to the mobile station through the end of the plan duration. Examples of weighted path search algorithms are Dijkstra's Shortest Path First algorithm, the A* search algorithm, and the D* search algorithm. Of course, other known weighted path search algorithms may be utilized.

From FIG. 20A and FIG. 20B it is clear that a metric may vary over the handover plan duration. This is especially true of cost terms or metrics that can vary in a step function manner, such as modulation and bandwidth. Additionally, initial costs for the various potential handover paths that may be taken by the mobile station are based on expected values (or estimates) of metrics, but during the course of executing a handover path by the mobile station, new measurements may be taken that allow real current values to replace the expected (or estimated) values. For instance, due to weather, changes in propagation conditions, error in determining mobile station position, or other events, real measured signal quality metrics may provide cost function metrics that differ from predicted metrics and therefore provide for the calculation of new, differently valued cost function metrics for future legs of the handover path. This may allow different handover paths to be taken than initially planned. For instance, if handover PATH2 above was chosen, but before the time to handover to LEO2 (in PATH2) occurred, the mobile station determined it could communicate with LEO2 with worse quality than expected but could communicate with LEO3 with better quality than expected, it would be advantageous for the mobile station to switch to handover PATH1 while time permitted.

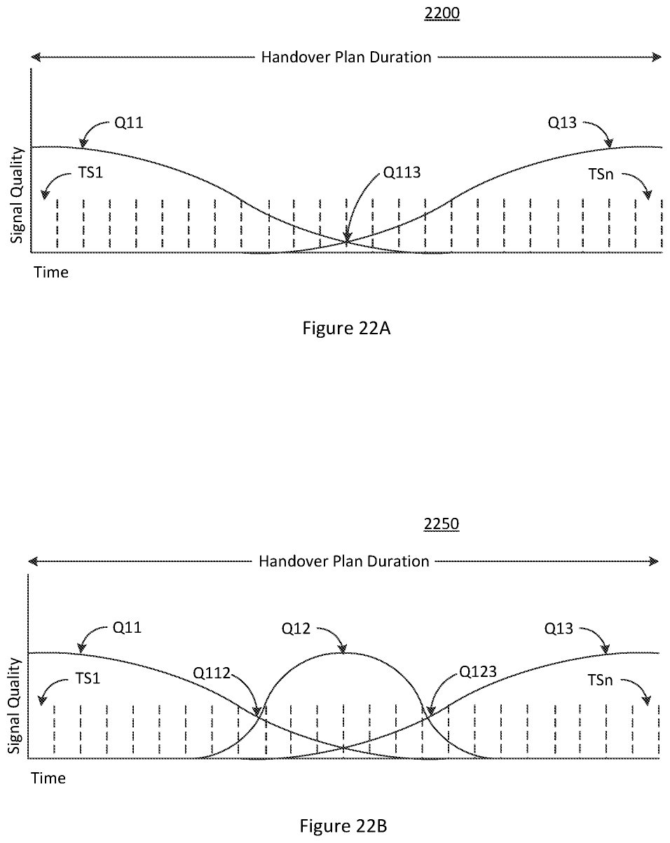

To more precisely account for the time varying nature of cost function metrics in order to more accurately apply their impact or to more quickly adjust handover paths in real time, the handover plan duration may be split into N time slices as shown in FIG. 22A and FIG. 22B.

The time slices may each be, for instance, 20 seconds or one minute in duration depending on how far ahead the planning is desired (the handover plan duration). For each handover path, cost function metrics are calculated for each time slice TS=1 through TS=n of the handover plan duration. The total cost function for the entire handover path (HO PATH X) is then the sum of the cost function for that handover path over all of the time slices of the handover plan duration. Equation 2 (EQ. 2) below is an example of such a total cost function over the multiple time slices of a handover plan duration.

$${Cost}_{HOPATHx} = {\sum }_{T S = 1}^{N} ( {a}_{T S} * {T}_{T S} + \frac{{b}_{T S}}{{Q}_{T S}} + \frac{{c}_{T S}}{B {W}_{T S}} + {d}_{T S} * D {e}_{T S} ) \qquad ( EQ . 2 )$$

Some metrics may need to be adapted for this method illustrated in EQ. 2. For instance, metric T_{TS} in EQ. 2 above may be a 1 or 0 to represent whether the communications in timeslot TS is mostly stable or unstable. Alternatively, T_{TS} could be 0 if it had any unstable portion. Alternatively, T_{TS} could be the percentage of time the communications are unstable in timeslot TS.

For metrics such as signal quality, for each timeslot the method may use the minimum or average of the signal quality over the timeslot.

Actual values for the metrics, as measured, may replace previously estimated values in this method. This, in turn allows new estimated values for future timeslots to be calculated based on the actual value(s). Additionally, the handover plan duration may be a sliding window. As time progresses, real metric values may be used to update the cost calculations over the handover plan duration and new timeslots may be appended to the end of the handover plan duration to maintain the handover plan duration. This addition of new time slots may be continuous, periodic, or event driven (e.g., upon completion of a handover).

One skilled in the art would understand that measurements and metrics of a communication link between the mobile station and a satellite may be measured on downlink signals over the communication link by the mobile station and on uplink signals over the communication link by the satellite. Measurements and metrics may be passed from mobile station to satellite and from satellite to mobile station. Calculation with and conversion of metrics may be performed by mobile stations, satellites, or other network nodes of a communication network. Estimates of metrics, derivation of weights and learning of weights for use in a cost function may be performed by mobile stations, satellites, or other network nodes of a communication network.

According to certain above-described aspects and accompanying figures, a mobile station, system, methods, and techniques are provided for improved reception and playback of content, such as streaming video, at a mobile station in a broadband communication network, such as a satellite communication network. It can be appreciated by those skilled in the art that the devices, system, methods, and techniques described herein can also be used for improved reception and use of other types of content at a device such as streaming audio, data files, commands, and other information.

According to certain above-described aspects and accompanying figures, communication handover management processes, techniques and methods are provided for conducting communication handover of a mobile station to one or more subsequent satellites so as to reduce adverse impacts of a poor communication link on communication-based services operating on the mobile station.

Those of skill will appreciate that the various method steps, illustrative logical and functional blocks, modules, units, and algorithm steps described in connection with the aspects disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular constraints imposed on the overall system and devices. Skilled persons can implement the described functionality in varying ways for each particular system, but such implementation decisions should not be interpreted as causing a departure from the scope of the invention described herein. In addition, the grouping of functions within a unit, module, block, or step is for ease of description. Specific functions or steps can be moved from one unit, module, or block without departing from the invention.

Some or all of the various illustrative methods, algorithms, logical and functional blocks, units, steps and modules described in connection with the aspects disclosed herein, and those provided in the accompanying documents, can be implemented or performed with a processor, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein, and those provided in the accompanying documents. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm and the processes of a block or module described in connection with the aspects disclosed herein, and those provided in the accompanying documents, can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC. Additionally, devices, blocks, or modules that are described as coupled may be coupled via intermediary devices, blocks, or modules. Similarly, a first device may be described as transmitting data to (or receiving from) a second device wherein there are intermediary devices that couple the first and second device and also wherein the first device is unaware of the ultimate destination of the data.

The above description of the disclosed aspects, and that provided in the accompanying documents, is provided to enable any person skilled in the art to make or use the invention. Various modifications to these aspects will be readily apparent to those skilled in the art, and the generic principles described herein, and in the accompanying documents, can be applied to other aspects without departing from the spirit or scope of the invention. Thus, it is to be understood that the description and drawings presented herein, and presented in the accompanying documents, represent particular aspects of the invention and are therefore representative examples of the subject matter that is broadly contemplated by the present invention. It is further understood that the scope of the present invention fully encompasses other aspects that are, or may become, understood to those skilled in the art based on the descriptions presented herein and that the scope of the present invention is accordingly not limited by the descriptions presented herein, or by the descriptions presented in the accompanying documents.

What we claim is:

1. A mobile station provided in a satellite communication network comprised of multiple orbiting satellites, the mobile station comprising:
a transceiver that is capable of communication with each of the multiple orbiting satellites, said communication comprising an uplink communication channel and a downlink communication channel;
a memory storing data and executable program instructions; and
a processor coupled to the transceiver and to the memory, the processor configured to execute the executable program instructions to manage satellite communication handover by performing the steps of:
maintaining a current communication link between the mobile station and a first orbiting satellite of the multiple orbiting satellites if a signal quality of the current communication link is greater than a first signal quality threshold,
identifying at least a second orbiting satellite and a third orbiting satellite of the multiple orbiting satellites as handover candidates based on a relative position of the mobile station to the multiple orbiting satellites, wherein a relative distance of the mobile station to the second orbiting satellite is less than a relative distance of the mobile station to the third orbiting satellite,
handing over communication of the mobile station to the third orbiting satellite if the signal quality of the current communication link is not greater than the first signal quality threshold and if a projected signal quality of a communication link between the mobile station and the third orbiting satellite is greater than a second signal quality threshold, and
handing over communication of the mobile station to the second orbiting satellite if the signal quality of the current communication link is not greater than the first signal quality threshold and if the projected signal quality of a communication link between the mobile station and the third orbiting satellite is not greater than a second signal quality threshold and if a projected signal quality of a communication link between the mobile station and the second orbiting satellite is greater than a third signal quality threshold.

2. The mobile station of claim 1 wherein execution of the executable program instructions by the processor performs the additional step of preparing the mobile station to enter a communication coverage gap if the signal quality of the current communication link is not greater than the first signal quality threshold and if the projected signal quality of a communication link between the mobile station and the third orbiting satellite is not greater than a second signal quality threshold and if the projected signal quality of a communication link between the mobile station and the second orbiting satellite is not greater than the third signal quality threshold.

3. The mobile station of claim 1 wherein the signal quality of the current communication link is based on a measurement by the transceiver of the mobile station.

4. The mobile station of claim 1 wherein the projected signal quality of the communication link between the mobile station and the third orbiting satellite, and the projected signal quality of the communication link between the mobile station and the second orbiting satellite are estimated based on past communication links between the mobile station and the third orbiting satellite and the second orbiting satellite, respectively.

5. A mobile station provided in a satellite communication network comprised of multiple orbiting satellites, the mobile station comprising:
a transceiver that is capable of communication with each of the multiple orbiting satellites, said communication comprising an uplink communication channel and a downlink communication channel;
a memory storing data and executable program instructions; and
a processor coupled to the transceiver and to the memory, the processor configured to execute the executable program instructions to manage satellite communication handover by performing the steps of:
determining a first available communication bandwidth and a first communication delay for a first potential communication link between the mobile station and a first orbiting satellite, and determining a second available communication bandwidth and a second communication delay for a second potential communication link between the mobile station and a second orbiting satellite,
selecting for communication handover of the mobile station, if the first available communication bandwidth and the second available communication bandwidth are not both above a first bandwidth threshold, one of the first orbiting satellite and the second orbiting satellite based on which one of the first available communication bandwidth and the second available communication bandwidth is highest, and
selecting for communication handover of the mobile station, if the first available communication bandwidth and the second available communication bandwidth are both above a first bandwidth threshold and if the first communication delay and the second communication delay are not both below a first delay threshold, one of the first orbiting satellite and the second orbiting satellite based on which one of the first communication delay and the second communication delay is lowest.

6. The mobile station of claim 5 wherein the first available communication bandwidth and the first communication delay are determined based on past measurements of past communication links between the mobile station and the first orbiting satellite, and the second available communication bandwidth and the second communication delay are determined based on based on past measurements of past communication links between the mobile station and the second orbiting satellite.

7. The mobile station of claim 5 wherein the first available communication bandwidth and the first communication delay are estimated based on a predicted relative distance between the mobile station and the first orbiting satellite and on transmission parameters of the mobile station and the first orbiting satellite, and the second available communication bandwidth and the second communication delay are estimated based on a predicted relative distance between the mobile station and the second orbiting satellite and on transmission parameters of the mobile station and the second orbiting satellite.

8. The mobile station of claim 5 wherein execution of the executable program instructions performs the additional step of selecting, if the first available communication bandwidth and the second available communication bandwidth are both above a first bandwidth threshold and if the first communication delay and the second communication delay are both below a first delay threshold, either one of the first orbiting satellite and the second orbiting satellite.

9. The mobile station of claim 5 wherein, in the case that the first orbiting satellite is selected when the first available communication bandwidth is greater than the second available communication bandwidth and the first communication delay is greater than the second communication delay and the second available communication bandwidth is not above the second bandwidth threshold, the executable program instructions executed by the processor further cause the mobile station to adjust buffering of a streaming video service to account for the first communication delay and to suspend any active communication services that cannot tolerate the first communication delay.

10. The mobile station of claim 5 wherein, in the case that the first orbiting satellite is selected for communication handover and the first communication delay is greater than a second delay threshold, the executable program instructions executed by the processor perform the additional step of adjusting a communication service operating on the mobile station to account for the first communication delay, and wherein, in the case that the second orbiting satellite is selected for communication handover and the second communication delay is greater than the second delay threshold, the executable program instructions executed by the processor perform the additional step of adjusting the communication service operating on the mobile station to account for the second communication delay.

11. A method for communication handover management of a mobile station provided in a satellite communication network comprised of multiple orbiting satellites, the method comprising the steps of:
maintaining a current communication link between the mobile station and a first orbiting satellite of the multiple orbiting satellites if a signal quality of the current communication link is greater than a first signal quality threshold,
identifying at least a second orbiting satellite and a third orbiting satellite of the multiple orbiting satellites as handover candidates based on a relative position of the mobile station to the multiple orbiting satellites, wherein a relative distance of the mobile station to the second orbiting satellite is less than a relative distance of the mobile station to the third orbiting satellite,
handing over communication of the mobile station to the third orbiting satellite if the signal quality of the current communication link is not greater than the first signal quality threshold and if a projected signal quality of a communication link between the mobile station and the third orbiting satellite is greater than a second signal quality threshold, and
handing over communication of the mobile station to the second orbiting satellite if the signal quality of the current communication link is not greater than the first signal quality threshold and if the projected signal quality of a communication link between the mobile station and the third orbiting satellite is not greater than a second signal quality threshold and if a projected signal quality of a communication link between the mobile station and the second orbiting satellite is greater than a third signal quality threshold.

12. The method of claim 11 wherein execution of the executable program instructions by the processor performs the additional step of preparing the mobile station to enter a communication coverage gap if the signal quality of the current communication link is not greater than the first signal quality threshold and if the projected signal quality of a communication link between the mobile station and the third orbiting satellite is not greater than a second signal quality threshold and if the projected signal quality of a communication link between the mobile station and the second orbiting satellite is not greater than the third signal quality threshold.

13. The method of claim 11 wherein the signal quality of the current communication link is based on a measurement by the transceiver of the mobile station.

14. The method of claim 11 wherein the projected signal quality of the communication link between the mobile station and the third orbiting satellite, and the projected signal quality of the communication link between the mobile station and the second orbiting satellite are estimated based on past communication links between the mobile station and the third orbiting satellite and the second orbiting satellite, respectively.

15. A method for communication handover management of a mobile station provided in a satellite communication network comprised of multiple orbiting satellites, the method comprising the steps of:
determining a first available communication bandwidth and a first communication delay for a first potential communication link between the mobile station and a first orbiting satellite, and determining a second available communication bandwidth and a second communication delay for a second potential communication link between the mobile station and a second orbiting satellite,
selecting for communication handover of the mobile station, if the first available communication bandwidth and the second available communication bandwidth are not both above a first bandwidth threshold, one of the first orbiting satellite and the second orbiting satellite based on which one of the first available communication bandwidth and the second available communication bandwidth is highest, and
selecting for communication handover of the mobile station, if the first available communication bandwidth and the second available communication bandwidth are both above a first bandwidth threshold and if the first communication delay and the second communication delay are not both below a first delay threshold, one of the first orbiting satellite and the second orbiting satellite based on which one of the first communication delay and the second communication delay is lowest.

16. The method of claim 15 wherein the first available communication bandwidth and the first communication delay are determined based on past measurements of past communication links between the mobile station and the first orbiting satellite, and the second available communication bandwidth and the second communication delay are determined based on based on past measurements of past communication links between the mobile station and the second orbiting satellite.

17. The method of claim 15 wherein the first available communication bandwidth and the first communication delay are estimated based on a predicted relative distance between the mobile station and the first orbiting satellite and on transmission parameters of the mobile station and the first orbiting satellite, and the second available communication bandwidth and the second communication delay are estimated based on a predicted relative distance between the mobile station and the second orbiting satellite and on transmission parameters of the mobile station and the second orbiting satellite.

18. The method of claim 15 wherein execution of the executable program instructions performs the additional step of selecting, if the first available communication bandwidth and the second available communication bandwidth are both above a first bandwidth threshold and if the first communication delay and the second communication delay are both below a first delay threshold, either one of the first orbiting satellite and the second orbiting satellite.

19. The method of claim 15 wherein, in the case that the first orbiting satellite is selected when the first available communication bandwidth is greater than the second available communication bandwidth and the first communication delay is greater than the second communication delay and the second available communication bandwidth is not above the second bandwidth threshold, the executable program instructions executed by the processor further cause the mobile station to adjust buffering of a streaming video service to account for the first communication delay and to suspend any active communication services that cannot tolerate the first communication delay.

20. The method of claim 15 wherein, in the case that the first orbiting satellite is selected for communication handover and the first communication delay is greater than a second delay threshold, the executable program instructions executed by the processor perform the additional step of adjusting a communication service operating on the mobile station to account for the first communication delay, and wherein, in the case that the second orbiting satellite is selected for communication handover and the second communication delay is greater than the second delay threshold, the executable program instructions executed by the processor perform the additional step of adjusting the communication service operating on the mobile station to account for the second communication delay.
